(19) United States
(12) Patent Application Publication
(10) Pub. No.: US 2020/0391230 A1
(43) Pub. Date: Dec. 17, 2020

(54) VISCOUS FOOD DISPENSING NOZZLE

(71) Applicant: Trade Fixtures, LLC, Little Rock, AR (US)

(72) Inventors: Scott Johnson, Little Rock, AR (US); Shaji Kulangara Veettil, Little Rock, AR (US); John Calow, North Little Rock, AR (US); John Clayton Odom, Benton, AR (US); Ronald Brundick, Roland, AR (US); Ashok Dyavarasegowda, Bangalore (IN)

(73) Assignee: Trade Fixtures, LLC, Little Rock, AR (US)

(21) Appl. No.: 16/897,783

(22) Filed: Jun. 10, 2020

Related U.S. Application Data
(60) Provisional application No. 62/859,839, filed on Jun. 11, 2019.

(51) Int. Cl. B05B 1/30; B05B 1/04; B02C 23/02; B02C 7/175; B02C 7/06

(52) U.S. Cl. CPC B05B 1/3006; B05B 1/044; B02C 7/06; B02C 7/175; B02C 23/02

(57) ABSTRACT

A nozzle for a viscous food dispensing system configured to dispense a viscous food product includes a nozzle passage extending from a nozzle inlet to a nozzle outlet, and a first port positioned proximate the nozzle outlet. A valve insert is positioned within the nozzle passage between the nozzle inlet and the first port, and the valve insert includes a second port. The first port and the second port are configured to move between an open position and a closed position in which flow from the nozzle inlet to the nozzle outlet is restricted by the second port then restricted by the first port.

### CROSS-REFERENCE TO RELATED APPLICATION

The present application claims priority of U.S. Provisional Patent Application No. 62/859,839, filed on Jun. 11, 2019, the contents of which are hereby incorporated by reference in its entirety.

### BACKGROUND

The present invention relates generally to viscous food product grinding and dispensing systems, and in particular to features for such systems configured to improve performance of the production of viscous food paste.

Grinding dispensers for dispensing bulk food products are used to dispense a wide variety of ground materials, which may include, for example, nuts, coffee, and grain. Generally, such systems include a hollow hopper-type bin having an inlet at an upper end utilized to fill the enclosure with bulk product, a transport section that receives the food product by gravity, a manual or electric motor power source that mechanically drives a transport device and a milling device, and a discharge cover for the milling device. The transport device may be a rotatable auger which is coupled to the power source. The discharge cover includes one or more outlet openings utilized to dispense the material into a container for the user.

Existing grinding dispenser systems provide nut butter freshly ground from various types of nuts, such as peanuts and almonds. In operation of such nut grinding dispensers, a pre-processed nut product is further ground to produce nut butter, which is forced as a viscous paste to the bottom of the discharge cover and dispensed from the outlet opening as an exposed viscous paste stream.

Conventional systems produce an exposed paste stream that is problematic for sanitary reasons. The present invention overcomes this disadvantage by covering dispense residual paste (commonly referred to as “dangle”) with a spout (aka shroud).

### SUMMARY

After the grinding dispenser has been deactivated, conventional systems further produce an exposed residue drip attached to the exterior of the product outlet. The present invention overcomes this disadvantage by providing a nozzle at the product outlet having a generally flexible valve configured to automatically pinch off product residue drips. Thus, the nozzle valve prevents dripping of the product after dispensing has ceased. In some embodiments, the nozzle is covered by a spout to shield the food product outlet from environmental contamination and public tampering.

Yet another improvement is achieved by the subject technology, especially suitable for production of low viscosity paste to prevent low viscosity food paste product from dripping from the valve outlet after dispensing has ceased. This low viscosity design can be either a one piece “double valve” specifically designed for use in low viscosity paste applications, or a valve insert to be installed inside the standard viscous product valve.

In an example, an outlet adapter includes a discharge cover and a flexible nozzle. The discharge cover is configured to receive a pressurized supply flow of particulate food product and to house a milling device for processing the particulate food product into a supply flow of viscous food paste for dispensing. The nozzle includes a proximal end, a distal end and a valve with a hollow interior passage. The nozzle is coupled at the proximal end to an aperture in the discharge cover. The hollow interior passage includes an opening at the proximal end configured to receive the viscous food paste. The hollow interior passage tapers downwardly towards a port at the distal end. The valve includes a flexible portion; the flexible portion is biased in a normally closed position and flexes to an open position under sufficient force for discharge of the viscous food paste. The flexible portion is configured such that force from the pressurized supply flow of the viscous food paste urges the port open and, once the supply flow stops, the port to returns to the closed position, thus pinching off or severing the viscous food paste.

An example of a nozzle for a viscous food dispensing system is configured to dispense a viscous food paste. The nozzle includes a nozzle passage defined by opposed side walls and opposed flap walls. The nozzle passage extends from a nozzle inlet to a nozzle outlet. A first port is positioned proximate the nozzle outlet. A valve insert is positioned within the nozzle passage between the nozzle inlet and the first port. The valve insert includes a second port. The first port and the second port are configured to move between an open position and a closed position in which flow from the nozzle inlet to the nozzle outlet is first restricted within the valve insert by the second port then restricted from the nozzle outlet by the first port.

Further examples of the nozzle may include the nozzle insert having a body configured to be received in the nozzle passage, the body including an insert passageway extending from an insert inlet to an insert outlet, and an outer surface configured to form a seal with an interior surface of the nozzle passage thereby directing flow of viscous food product through the insert passageway. The outer surface of the valve insert proximate the insert inlet may be contoured to match interior surface of the nozzle passage proximate the nozzle inlet. The body of the valve insert may include opposed flap walls and opposed lateral walls and the opposed lateral walls of the body of the valve insert engage the interior surface of the nozzle passage at the side walls along a length of the opposed lateral walls. The opposed flap walls of the body of the valve insert angle interiorly away from the interior surface of the nozzle passage at the flap walls defining the nozzle passage to form a gap therebetween.

In other examples, the second port may include opposing gates positioned on insert flap walls that extend towards each other from opposite sides of the nozzle passage. The insert flap walls are configured to flex outward to move the opposing gates away from each other thereby moving second port into the open position from the closed position, and to flex inward to move the opposing gates towards each other thereby moving the second port into the closed position from the open position. The opposing gates may converge on a narrow aperture between the opposing gates when the second port is in the closed position. The opposing gates may be configured to move away from each other to expand the aperture when the second port moves from the closed position to the open position. The opposing gates may be configured to engage when the second port is in the closed position. The opposing gates may be configured to move away from each other out of engagement to form an aperture when the second port moves from the closed position to the open position. A gap is formed between an outer surface of the insert flap walls and an interior surface defining the nozzle passage.

A system for grinding nuts into a food paste and dispensing the paste therefrom includes an auger for preprocessing nuts into nut particulates. A milling device receives nut particulates and grinds the nut particulates into a pressurized flow of viscous food paste. A discharge cover surrounds at least a portion of the milling device. The discharge cover directs the viscous food paste away from the milling device. A nozzle is fluidly connected to the discharge cover. The nozzle includes a nozzle passage defined by opposed side walls and opposed flap walls, the nozzle passage extends from a nozzle inlet to a nozzle outlet. A first port is positioned proximate the nozzle outlet. A valve insert is positioned within the nozzle passage between the nozzle inlet and the first port. The valve insert includes a second port. The first port and the second port are each configured to move between an open position and a closed position in which flow from the nozzle inlet to the nozzle outlet is first restricted within the valve insert by the second port then restricted from the nozzle outlet by the first port.

Additional examples of the system include the milling device includes texture adjustment to provide food pastes with a variety of viscosities. The valve insert includes a body configured to be received in the nozzle passage, the body including an insert passageway extending from an insert inlet to an insert outlet, and an outer surface configured to form a seal with an interior surface of the nozzle passage thereby directing flow of viscous food product through the insert passageway. The outer surface of the valve insert proximate the insert inlet is contoured to match interior surface of the nozzle passage proximate the nozzle inlet, the body of the valve insert comprises opposed lateral walls that engage the interior surface of the nozzle passage at the side walls along a length of the opposed lateral walls, and the body of the valve insert comprises opposed flap walls that angle interiorly away from the interior surface of the nozzle passage at the flap walls defining the nozzle passage to form a gap therebetween.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a schematic side view of a viscous food product grinding and dispensing system;

FIG. 2 is a schematic flow diagram of the system of FIG. 1;

FIG. 3 is a partial front perspective view of a viscous food product grinding and dispensing system according to an embodiment of the present invention, shown without the milling device;

FIG. 4 is a front perspective view of the bin of FIG. 3 shown removed from the system;

FIG. 5 is a rear perspective view of the bin of FIG. 4;

FIG. 6A is a partial top plan view of the system of FIG. 3 shown with the bin, front rotating grinder and discharge cover removed;

FIG. 6B is a front end view in section of a cutout in the auger/transport device, and FIG. 6C, is the section of FIG. 6B shown rotated counterclockwise, also showing the interior surface of the adjacent sleeve;

FIG. 6D is a front end view in section of a cutout in the auger/transport device (identical to FIG. 6B), FIG. 6E is the section of FIG. 6D shown rotated counterclockwise showing a captured nut, and FIG. 6F is the section of FIG. 6E shown rotated further counterclockwise showing a partially crushed nut (it should be noted that the same effect can be achieved with a clockwise configuration);

FIG. 6G is a front end view in section of a cutout in a prior art device, FIG. 6H is the section of FIG. 6G shown rotated counterclockwise showing an un-captured nut, and FIG. 6I is the section of FIG. 6H shown rotated further counterclockwise, and showing an escaped nut;

FIG. 6J is a top perspective view of the system of FIG. 6A;

FIG. 6K is an exploded side perspective view showing the transport section with transport device of FIG. 3;

FIG. 7 is a front perspective view of the system of FIG. 6A shown with the rear fixed grinder removed;

FIG. 8 is a front perspective view of the system of FIG. 6A;

FIG. 9 is a side perspective view of the system of FIG. 3 shown with the front rotating grinder and discharge cover removed;

FIG. 10 is an exploded view of the system according to an embodiment of the present invention, shown with the bin removed;

FIG. 11 is the exploded view of FIG. 10 shown without the power source and enclosure;

FIG. 12 is a rear perspective view of the power source and enclosure of FIG. 10 shown with a rear portion of the enclosure removed;

FIG. 13 is a partial rear perspective view of the power source enclosure of FIG. 10;

FIG. 14 is a block diagram of the power source of FIG. 10;

FIG. 15 is a schematic side view of a viscous food product grinding and dispensing system with alternative outlet adapter;

FIG. 16 is a schematic flow diagram of the system of FIG. 15;

FIG. 17 is an exploded view of the transport section, outlet adapter, and milling device of FIG. 15;

FIG. 18 is a partial top plan view of the assembled transport device inside the front housing of FIG. 17;

FIG. 19 is a top plan view of the auger/transport device of FIG. 17;

FIG. 20 is a rear view in section of the transport device of FIGS. 18 and 19;

FIG. 21 is a rear perspective view of the outlet adapter of FIG. 17 with the nozzle assembled inside the discharge cover;

FIG. 22 is a front perspective view of the outlet adapter of FIG. 21;

FIG. 23 is a front view of the outlet adapter of FIG. 21;

FIG. 24 is a short side view in section of the outlet adapter of FIG. 21;

FIG. 25 is a right side perspective view in section of the outlet adapter of FIG. 21;

FIG. 26 is a left side perspective view in section of the outlet adapter of FIG. 21;

FIG. 27 is a bottom front perspective view of the flexible nozzle of FIG. 17;

FIG. 28 is a top rear perspective view of the flexible nozzle of FIG. 27;

FIG. 29 is a top plan view of the flexible nozzle of FIG. 28;

FIG. 30 is a rear elevation view of the flexible nozzle of FIG. 28;

FIG. 31 is a horizontal section view of the flexible nozzle of FIG. 28,

FIG. 32 is a bottom plan view of the flexible nozzle of FIG. 28;

FIG. 33 is a front elevation view of the flexible nozzle of FIG. 28;

FIG. 34 is a left side elevation view of the flexible nozzle of FIG. 28;

FIG. 35 is a right side elevation view of the flexible nozzle of FIG. 28;

FIG. 36 is a top plan view of a reference planar oval relative to the flexible nozzle of FIG. 28;

FIG. 37 is a long side view in section of the flexible nozzle of FIG. 28;

FIG. 38 is a short side view in section of the flexible nozzle of FIG. 28 prior to the flow of viscous food product;

FIG. 39 is the flexible nozzle of FIG. 38 deformed during the flow of viscous food product;

FIG. 40 a bottom view of the deformed valve of the nozzle of FIG. 39;

FIG. 41 is a rear perspective view of an outlet adapter according to another embodiment of the present invention;

FIG. 42 is a bottom perspective view of the flexible nozzle of FIG. 18;

FIG. 43 is a top perspective view of the flexible nozzle of FIG. 18;

FIG. 44 is a top plan view of the flexible nozzle of FIG. 43;

FIG. 45 is a front elevation view of the flexible nozzle of FIG. 43;

FIG. 46 is a bottom plan view of the flexible nozzle of FIG. 43;

FIG. 47 is a long side view in section of the flexible nozzle of FIG. 43;

FIG. 48 is a short side view in section of the flexible nozzle of FIG. 43 prior to the flow of viscous food product;

FIG. 49 is the flexible nozzle of FIG. 26 deformed during the flow of viscous food product;

FIG. 50 is a bottom view of the flexible nozzle of FIG. 43 deformed during the flow of viscous food product; and

FIG. 51 is a sectional view of a nozzle taken along a Y-Z plane;

FIG. 52 is a sectional view of the nozzle taken along the X-Z plane;

FIG. 53 is a front perspective view of a valve insert;

FIG. 54 is a bottom perspective view of a valve insert;

FIG. 55 is a sectional view taken along line 55-55 of FIG. 53; and

FIG. 56 is a bottom perspective view of the valve insert of FIG. 55.

### DETAILED DESCRIPTION

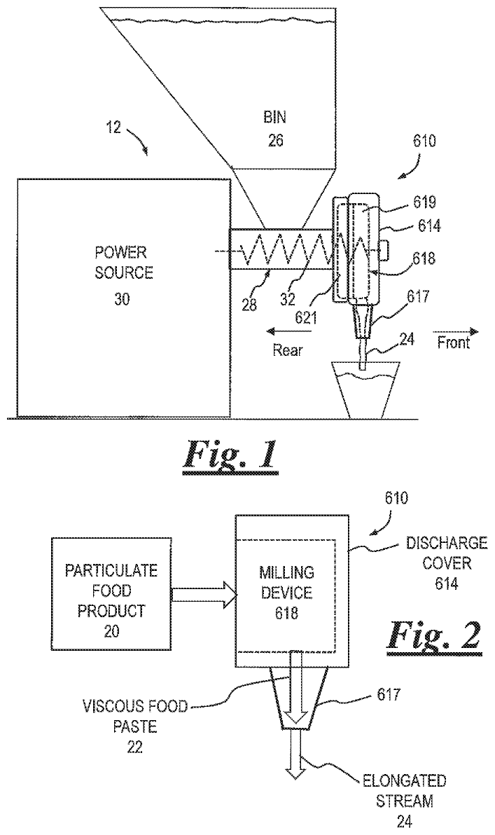

The general arrangement of a food product grinding and dispensing system 12 is shown in FIGS. 1 & 2. Examples of food product grinding and dispensing systems are also provided in US Patent Application Publication No. 2017/02167441, entitled, “Viscous Food Product Grinding and Dispensing System” and in U.S. patent application Ser. No. 16/816,647 entitled, “Viscous Food Product Grinding and Dispensing System,” both of which are incorporated herein in their entireties. System 12 includes an outlet adapter 610 having a discharge cover 614 with a spout 617. Discharge cover 614 is configured to house a milling device 618 and to be operatively connected to a transport section 28 of system 12. Milling device 618 includes an opposing set of grinding members or plates, such as front rotating grinder 619 and a rear fixed grinder 621. Front rotating grinder 619 is adapted to rotate with respect to rear fixed grinder 621.

In operation, milling device 618 receives a supply flow of particulate food product 20 and processes the particulate food product into a pressurized supply flow of viscous food paste 22 for dispensing through spout 617 as an elongated stream 24. Food product 20 may include a variety of nuts, including peanuts and almonds. Viscous food paste 22 may include a variety of nut butters, such as peanut butter and almond butter.

System 12 includes a bin 26 for storage of particulate food product 20, gravity fed transport section 28 that receives the particulate food product, and a power source 30 that drives a transport device 32 as well as milling device 618. Transport device 32 is located within transport section 28 and operates to move particulate food product 20 downstream to milling device 618.

Transport device 32 is exemplarily an auger, which is designed to work in conjunction with the internal features of transport section 28 in order to perform an initial processing of the particulate food product 20. The initial processing involves a rough cutting and crushing of the product. The subsequent processing of the rough product involves relatively finer grinding performed by the milling device 618.

In the example shown in FIGS. 1 and 2, elongated stream 24 bifurcates upon cessation of flow leaving a residual, or dangle. As described more fully herein, the outlet adapter further includes a flexible discharge nozzle adapted to pinch off or sever stream 24 upon cessation of flow.

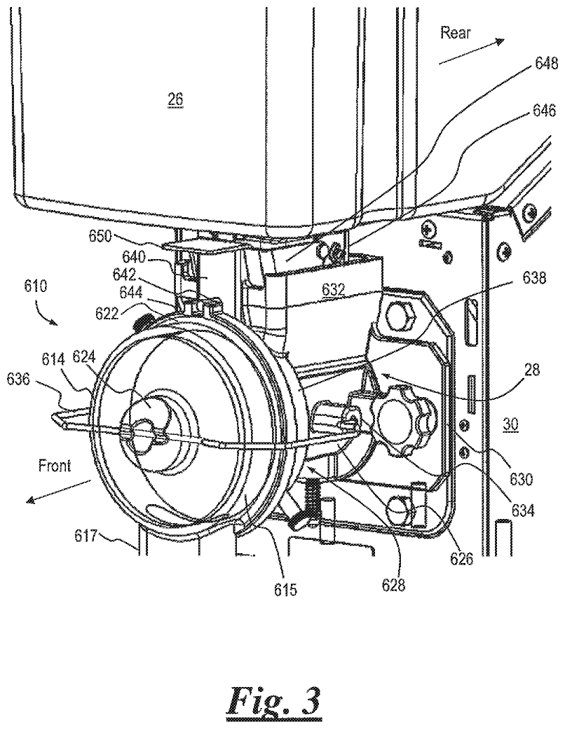

Now referring to FIG. 3, discharge cover 614 (viewed as if transparent) has a generally cylindrical shape and includes an annular sidewall 615, annular flange 622 at the rear, and a nose 624 at the front. Transport section 28 includes a sleeve 626, a front housing 628, a rear plate 630, and a chute inlet 632 extending from the top of the sleeve. Sleeve 626 further includes a pair of opposing nodes 634 configured to receive and secure opposing ends of a clamp bar 636. Nose 624 is configured to receive and secure a front portion of clamp bar 636. Front housing 628 includes an annular perimeter 638 and an arm 640 extending from the top of the annular perimeter and connected to the front of chute inlet 632. A post 642 is fastened to the front of arm 640. In assembling discharge cover 614 to front housing 628, a receptor 644 on top of annular flange 622 is first aligned with and inserted onto post 642. Next, clamp bar 636 is secured to nose 624 and the ends of the clamp bar secured to nodes 634. Alternatively, discharge cover 614 is aligned against front housing 628, secured by clamp bar 636, and then post 642 is fastened to arm 640 through receptor 644.

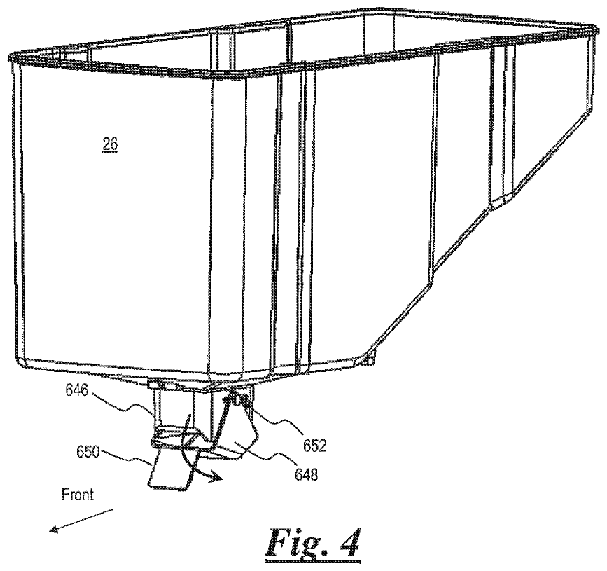

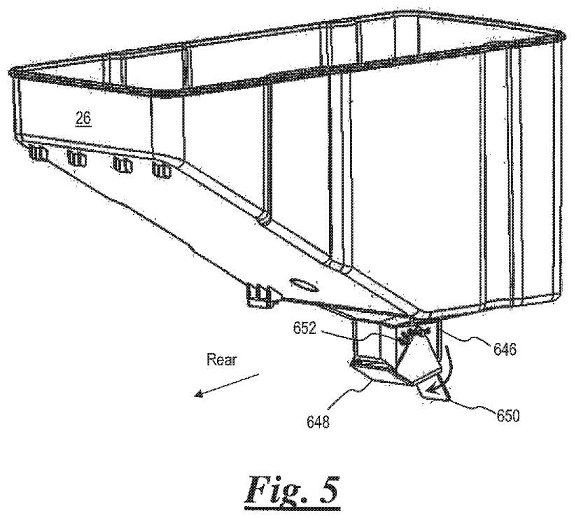

Bin 26 includes a chute 646 at the bottom for discharge of particulate food product 20. Bin 26 further includes a rotatable gate 648 configured to pivot from a normally closed position to an open position. In the closed position (FIGS. 4, 5), gate 648 covers the bottom opening of chute 646, preventing discharge of particulate food product 20. In the open position (FIG. 3), gate 648 is pivoted away from the bottom opening of chute 646 towards the front of the chute, thus allowing for product discharge. In assembling bin 26 to transport section 28, chute 646 is inserted into chute inlet 632. During insertion of chute 646 the top of arm 640 engages a flap 650, causing the front rotation of gate 648.

Referring to FIGS. 4 and 5, bin 26 may be removed from transport section 28 for cleaning and/or change-over of product. Upon removal of chute 646 from chute inlet 632, flap 650 rotates (either by gravity or spring assisted), thus pivoting gate 648 back to the closed position. Chute 646 further includes an opposing pair of stops 652 positioned on the sides of the chute. Stops 652 define a limit of movement of gate 648 in the closed position. Thus, gate 648 acts to minimize or substantially eliminate leakage of product from the bottom opening of chute 646 during removal of bin 26.

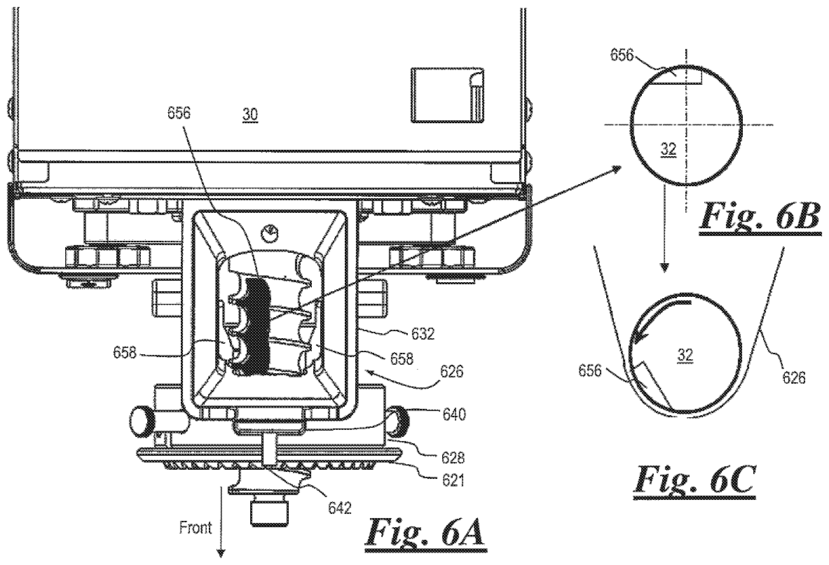

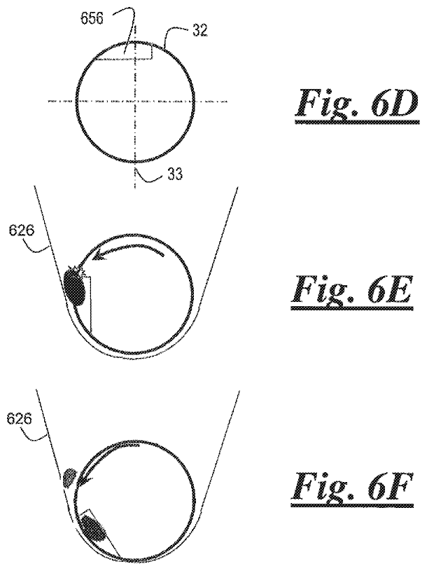

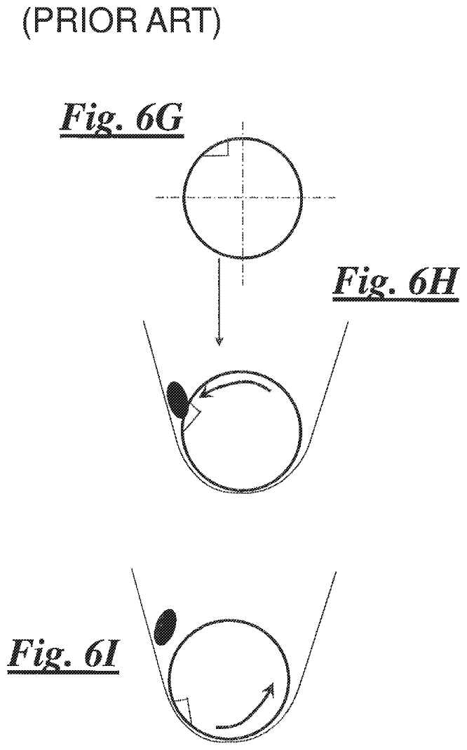

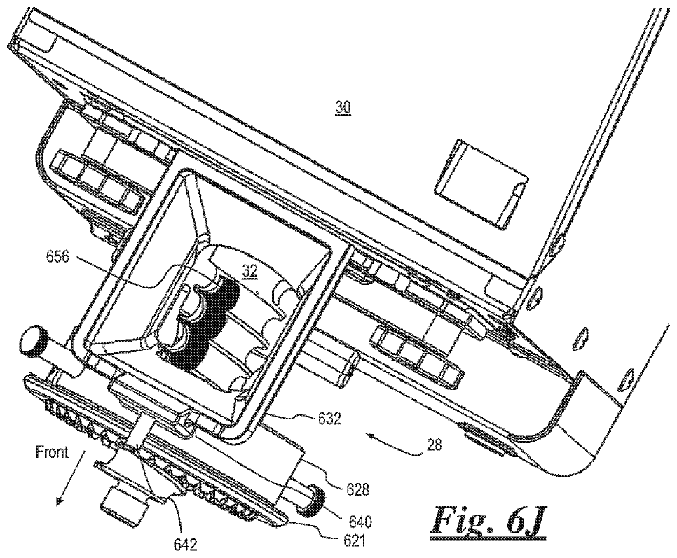

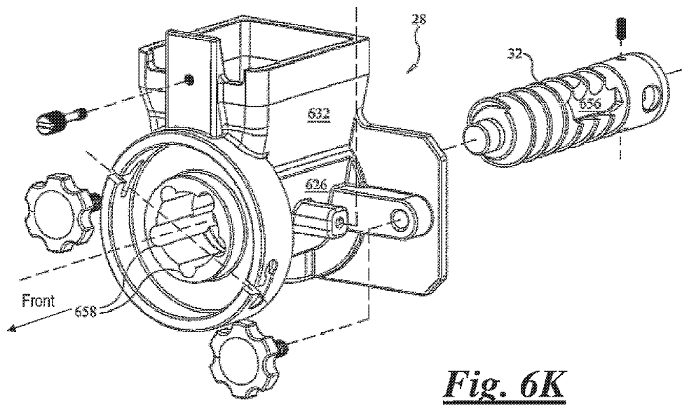

Referring to FIGS. 6A-6K, cutout portion 656 (aka over-center cutout) is disposed in transport device 32. As exemplified in FIG. 6B, cutout portion 656 is disposed in transport device 32 in an over-center position. Cutout portion 656 is formed as a notch having two perpendicular sides of unequal length. Cutout portion 656 is aligned below the opening of chute inlet 632. Those of skill in the art will appreciate that the dimensions of cutout portion 656 are sized commensurate with a target product (e.g. almond, or peanut). In an example, dimensions of 7.637 mm and 16.665 mm are used.

The foregoing configuration provides advantage in processing whole nuts (e.g. almonds or peanuts) can be captured and broken, whereas other systems require a pre-processed, partially broken product. As shown in FIGS. 6E & 6F, cutout portion 656 engages and breaks a whole nut against chamber wall (sleeve 626). As shown in FIGS. 6G through 6I, the inferior cutout of conventional systems cannot capture and break a whole nut because it pops out and escapes.

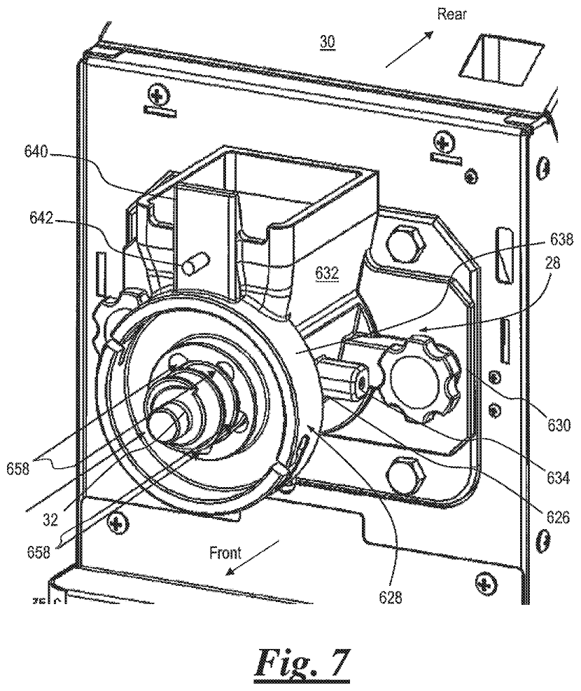

Referring to FIGS. 6K and 7, the rear portion of front housing 628 includes a plurality of radially equally spaced-apart flutes 658 disposed around transport device 32. Flutes 658 are longitudinal recesses along a portion of the interior surface of sleeve 626, configured in number and size to maximize product flow from sleeve 626 forward toward milling device 618. In the embodiment shown in FIG. 6K, the bottom three flutes 658 extend rearwardly along the interior surface of sleeve 626 below chute inlet 632 (see also FIG. 6A).

The number and size of flutes can be varied to adjust flow. In one embodiment (FIG. 7), five flutes, each being approximately 8 mm in diameter, half depth, are utilized. In another embodiment, 4 flutes are used which results in a lower flow rate and lower current draw on the motor.

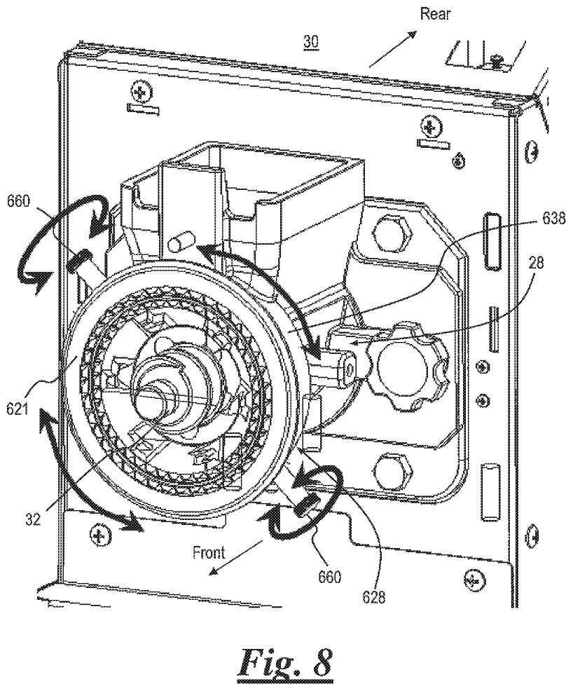

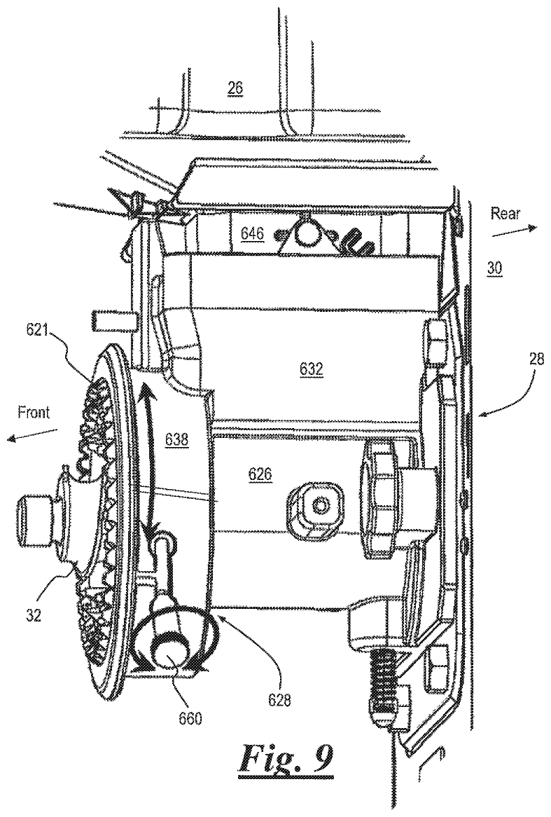

Referring to FIGS. 8 and 9, a pair of opposing texture adjustment screws 660 accessible through annular perimeter 638 allow adjustment of viscous food paste texture from coarse to fine. For nut products, the adjustments result in crunchy or creamy nut butter. Texture adjustment screws 660 are inserted through openings in annular perimeter 638 and are secured in corresponding helical slots within rear fixed grinder 621. Adjustment is made by loosening texture adjustment screws 660 and rotating the rear fixed grinder 621, relative to the longitudinal axis of transport device 32, into the desired position closer or further away from front rotating grinder 619, then re-tightening the texture adjustment screws. Preferably, the adjustment does not require the use of special tools, and the screws can be manually rotated. The top end of texture adjustment screws 660 may be any suitable type of thumb screw, such as including a knurled surface to allow ease of manual operation.

Referring to FIGS. 10 and 11, manual fasteners may be used for assembly and disassembly of transport section 28, transport device 32, and outlet adapter 610 from power source 30. Assembly and disassembly without special tools acts to reduce device-cleaning time and product change-over time, and reduces the potential for loss of special tools. Referring to FIG. 10, power source 30 is protected by an enclosure 662. A backer plate 664 is secured to enclosure 662 via thumb screws 666. A ring 668 is placed in an opening in backer plate 664, and a shaft 670 of a motor 672 (see motor in FIG. 12) extends forward through the opening.

The rear end of transport device 32 is secured to shaft 670 via screw set 674. Next, transport section 28 is inserted onto transport device 32 and rear plate 630 is secured to backer plate 664 via knobs 676. Then the transport device is secured to the transport section via fastener set 678. The rear fixed grinder is secured to front housing 628 via texture adjustment screws 660, as described above. Front rotating grinder 619 is inserted onto the front of transport device 32, and outlet adapter 610 is secured to front housing 628 via post 642 and clamp bar 636 as described above. Thus, as the front end of transport device 32 is coupled to front rotating grinder 619, the front rotating grinder is operably coupled to power source 30.

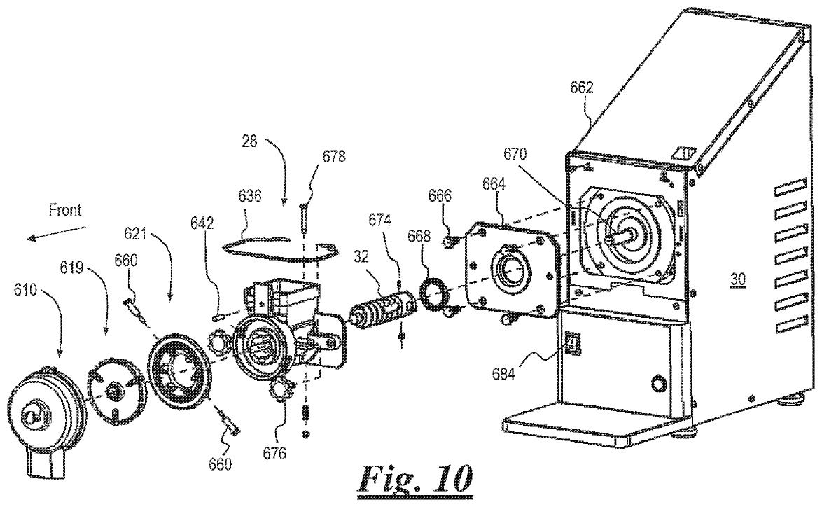

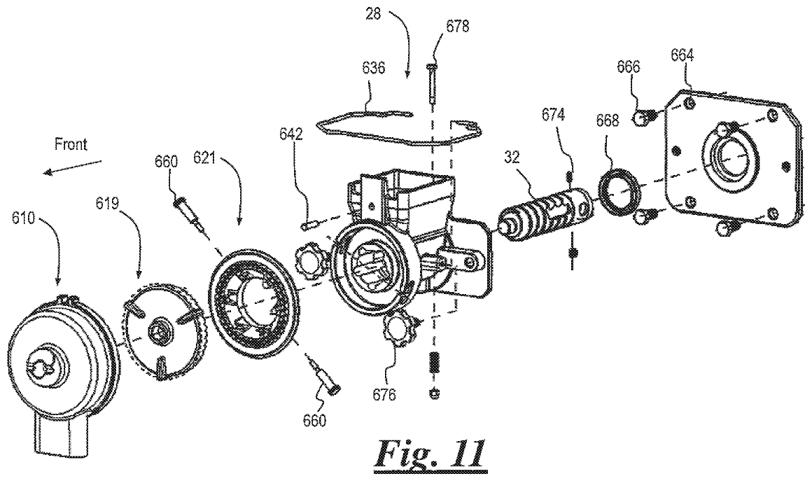

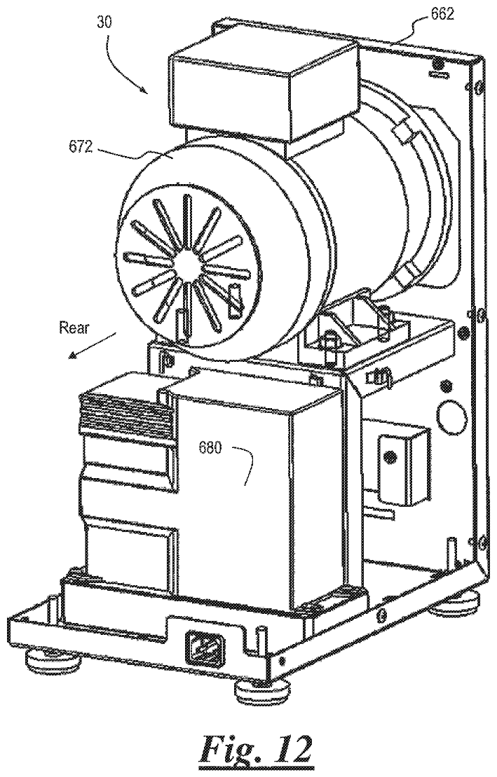

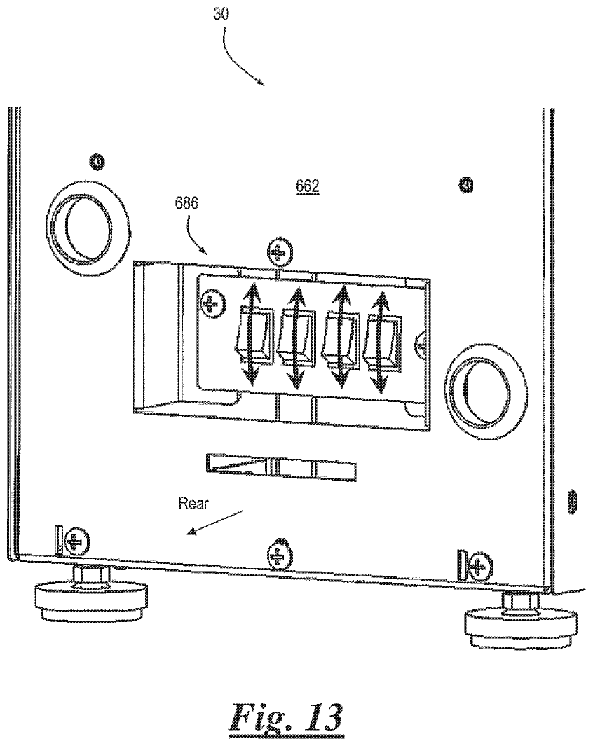

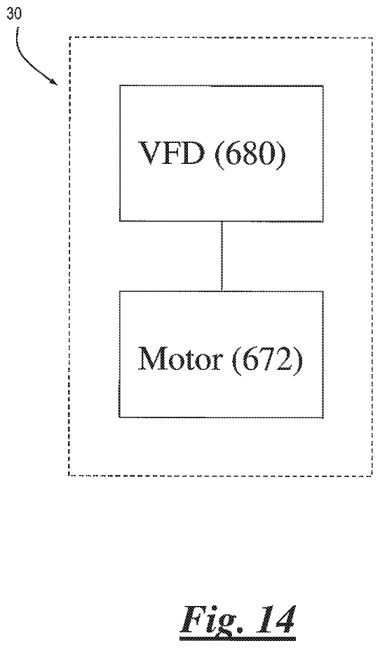

Referring to FIGS. 12 through 14, power source 30 further includes a variable frequency drive (VFD) controller 680 operatively connected to motor 672. VFD controller 680 is in electrical communication with motor 672 and operator interfaces, which include an on/off switch 684 (shown in FIG. 10) and a time adjustment feature 686 (shown in FIG. 13).

VFD controller 680 enables motor 672 to operate using various world-wide input voltages and frequencies, and maintains improved torque and horsepower. Further, VFD controller 680 includes overload protection with single push button recovery and PLC controllability to provide specific user-selectable and customizable torque/speed profiles via computer program profiles.

Referring to FIG. 13, a group of toggle switches in the rear side of enclosure 662 facilitates a time adjustment feature 686. The switches are operatively connected to VFD controller 680. Time adjustment feature 686 allows selection from a plurality of pre-determined run times for motor 672. For example, the pre-determined run times may be selected from a range of 15 seconds to 180 seconds. Time adjustment feature 686 is a “user-friendly” feature that takes the guess work out of adjusting unit run time. For example, it may include a series of four toggle switches, the first switch corresponding to 15 seconds, the second corresponding to 70 seconds, the third corresponding to 125 seconds and the fourth corresponding to 180 seconds run time. User positioning of on/off switch 684 to the “on” position causes activation of system 12 through VFD controller 680. Activation of system 12 causes motor 672 to operate for the maximum pre-determined run time, unless overridden by the user positioning the on/off switch 684 to the “off” position.

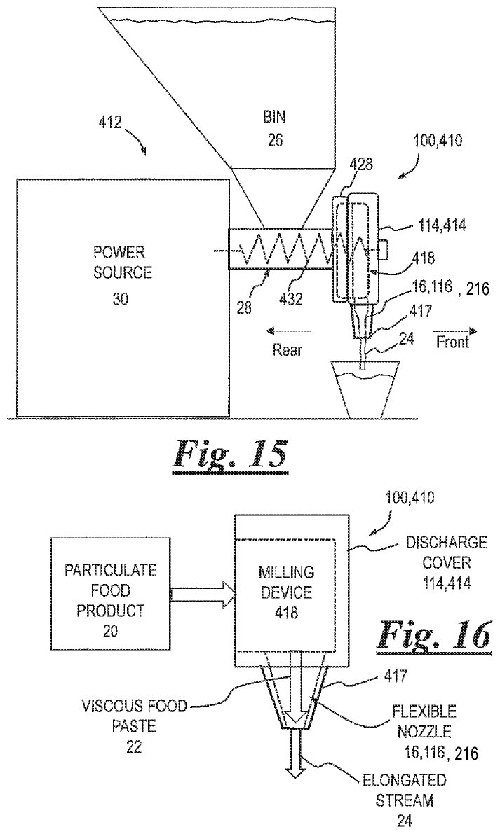

The general arrangement of alternative outlet adapters 100/410 for a viscous food product grinding and dispensing system 412 are shown in FIGS. 15 and 16. Outlet adapters 100/410 include a discharge cover 114/414 and a flexible nozzle 16/116. Discharge covers 114/414 are configured to house a milling device 418 (similar to milling device 618) and to receive flexible nozzle 16/116. System 412 includes a bin 26 for storage of particulate food product 20, gravity fed transport section 28 that receives the particulate food product and a power source 30 that drives a transport device 432 as well as milling device 418. Transport device 432 is located within transport section 28 and operates to move particulate food product 20 downstream to milling device 418. In operation, milling device 418 receives a supply flow of particulate food product 20 and processes the particulate food product into a pressurized supply flow of viscous food paste 22 for dispensing through nozzle 16/116 as an elongated stream 24.

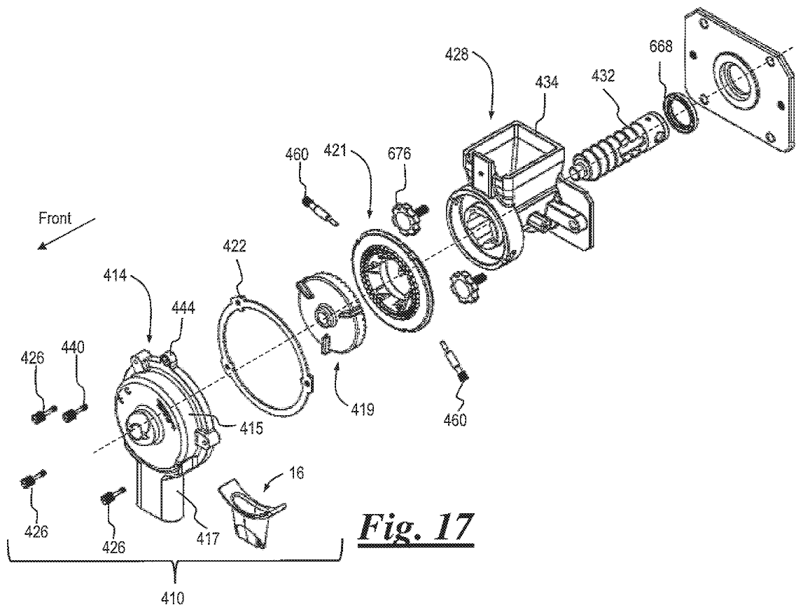

Now referring to FIG. 17, discharge cover 414, being similar to discharge cover 614, has a generally cylindrical shape and includes an annular sidewall 415. Discharge cover 414 also includes a spout 417 configured to act as an environmental guard and tamper deterrent for surrounded flexible nozzle 16.

The interior of discharge cover 414 may be curved to align adjacent the outer curved surface of milling device 418. Milling device 418 includes a front rotating grinder 419 and a rear fixed grinder 421.

Outlet adapter 410 also includes a gasket 422 fastened to the rear of discharge cover 414 via fasteners 426. Gasket 422 provides improved sealing of discharge cover 414 against rear fixed grinder 421. In assembly, discharge cover 414 with gasket 422 is aligned against a front housing 428, (may be secured by clamp bar 636, similar to discharge cover 614), and then post 440 is fastened to front housing 428 through receptor 444. Post 440 and fasteners 426 are configured to allow for installation both manually and by use of tools.

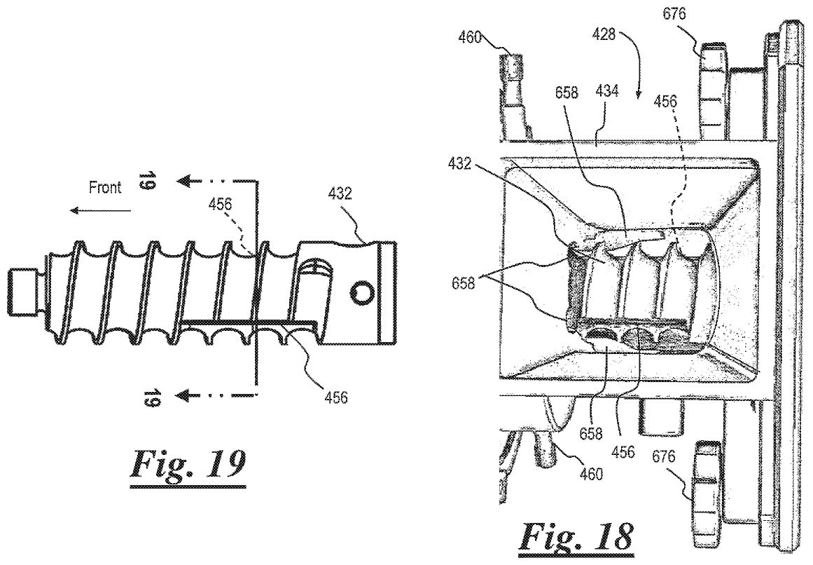

Now referring to FIGS. 18A, 18B and 19, transport device 432 is similar to transport device 32, except for including a hollow bore portion 454, and having two opposing cutouts 456 disposed at approximately 180 degrees out of phase, relative to each other. Cutouts 456 are aligned below the opening of a chute inlet 434.

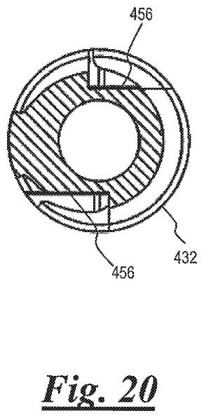

Referring to FIG. 20, in some embodiments, transport device 432 is solid, and does not include hollow bore portion 454. In one embodiment, transport device 432 is formed with an outer diameter of about 35.5 mm, and cutouts 456 are formed with a depth of about 7.637 mm and a width of about 16.665 mm.

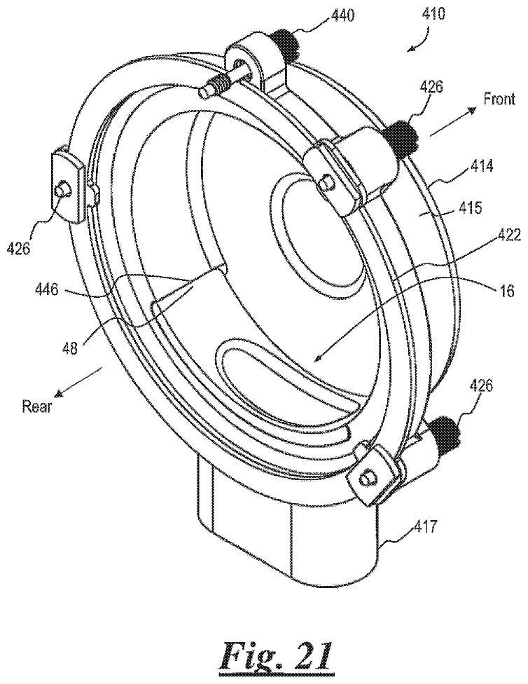

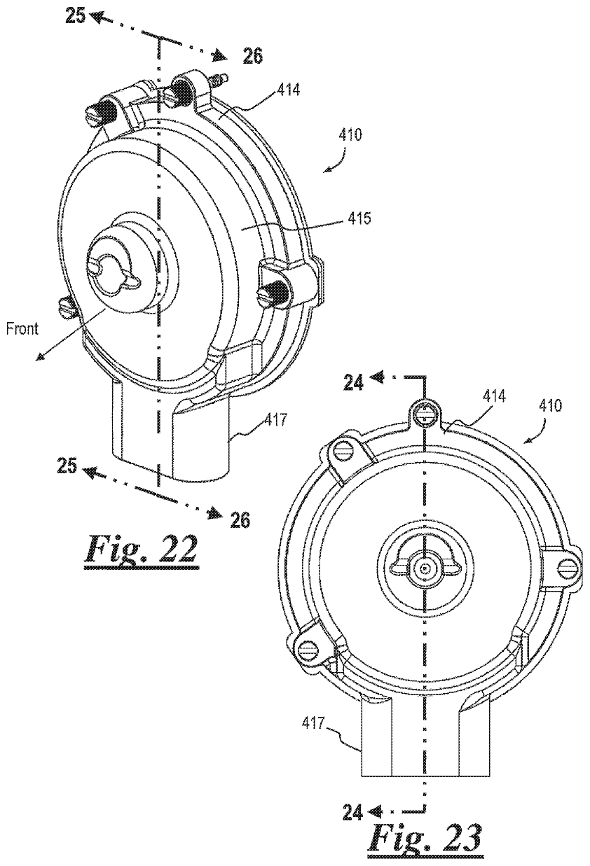

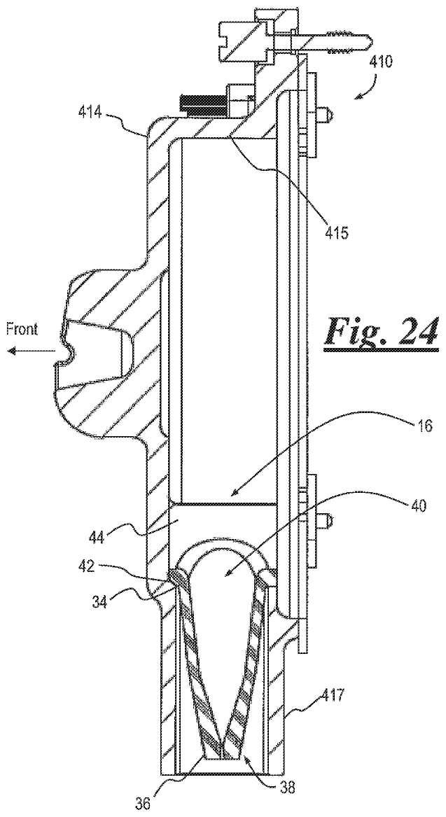

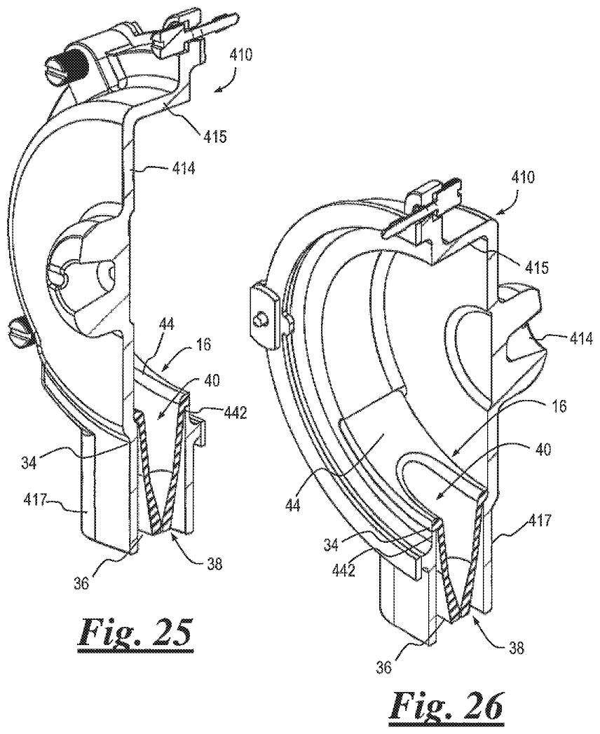

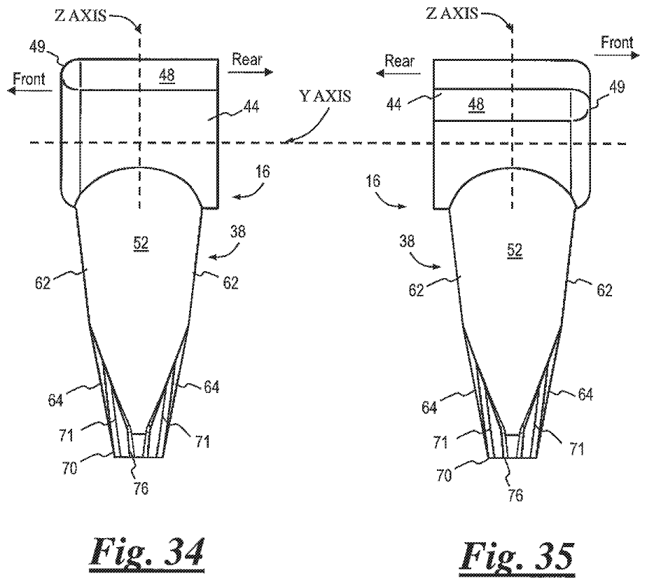

Now referring to FIGS. 21-26, spout 417 extends from the bottom of annular sidewall 415, and encloses all of flexible nozzle 16, except the bottom outlet. Spout 417 may be integral or ancillary to outlet adapter 410. Referring to FIGS. 24-26, nozzle 16 includes a proximal end 34, a distal end 36. A valve 38 with a hollow interior passage 40 is formed in the nozzle. Nozzle 16 is coupled at the proximal end 34 to an aperture 442 in annular sidewall 415 of discharge cover 414. Nozzle 16 includes a mounting flange 44 at the proximal end 34 configured to fit against the concave curved interior surface of discharge cover 414. As seen in FIG. 21, discharge cover 414 may include a shoulder 446 configured to abut the outer edges 48 of mounting flange 44. As best seen in FIGS. 34 and 35, a perimeter edge 49 of flange 44 may include radius curved portions configured to seal against concave curved interior edge portions of discharge cover 414.

Valve 38 is biased in a normally closed position and flexes to an open position due to a pressure exerted by the discharge of viscous food paste 22 as it is forced downstream through interior passage 40, and returns to the normally closed position upon flow cessation. Valve 38 is configured with interior geometry features that pinch or chop against elongated stream 24 as the valve returns to the closed position, effectively slicing through, pinching, or breaking apart the elongated stream. Pinching elongated stream 24 within valve 38 reduces the amount of paste residue attached to the external face of the bottom of the valve after the valve returns to the closed position.

In some embodiments, the properties of viscous food paste 22 allow for an alternative flexible nozzle to be utilized. Such flexible nozzle has a discharge opening that also enlarges, or deforms, due to product stream pressurization, and returns to the closed position upon flow cessation. The severing of elongated stream 24 leaves substantially no paste residue attached to the external face of the bottom of the valve after the stream flow is de-pressurized.

In some embodiments, the properties of viscous food paste 22 allow for an alternative rigid or semi-rigid nozzle to be utilized. Such properties of viscous food paste 22 inherently result in a clean drop or severing of elongated stream 24 due to forces of gravity once the supply flow is depressurized. Such natural severing of elongated stream 24 leaves substantially no paste residue attached to the external face of the bottom of the valve after the stream flow is de-pressurized. In some embodiments, such clean dropping viscous food paste 22 may be dispensed with just the discharge cover in place, without any nozzle inserted. In some embodiments, the discharge cover does not utilize spout 417, and a separate, plastic sneeze guard (not shown) is supported in front of the discharge of valve 38.

In some embodiments, a suitable biasing device, such as a pinch roller set (not shown) is used to assist flexible nozzle 16 in returning to its original, closed position after the stream flow is de-pressurized. In operation, once the stream flow is de-pressurized, the pinch roller set is activated adjacent to proximal end 34 of valve 38. The rollers of the pinch roller set are urged closer together to slightly compress valve 38 as the rollers are moved downwardly towards the distal end 36. As valve 38 returns to the closed position, elongated stream 24 is severed, and leaves substantially no paste residue attached to the external face of the bottom of the valve. The pinch roller set is thereafter returned to a starting position. The operation of the pinch rollers can be achieved by various methods, including full or partial automation.

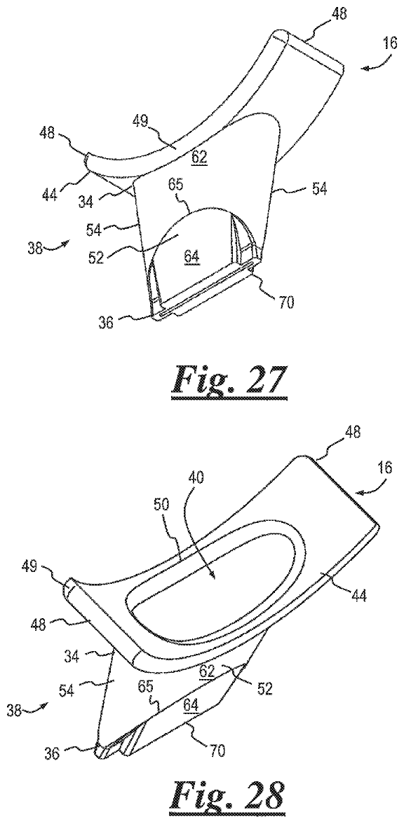

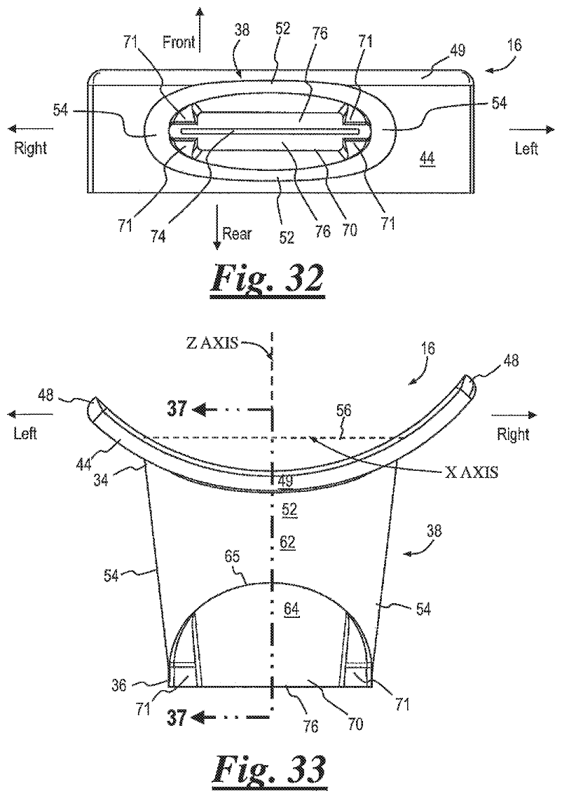

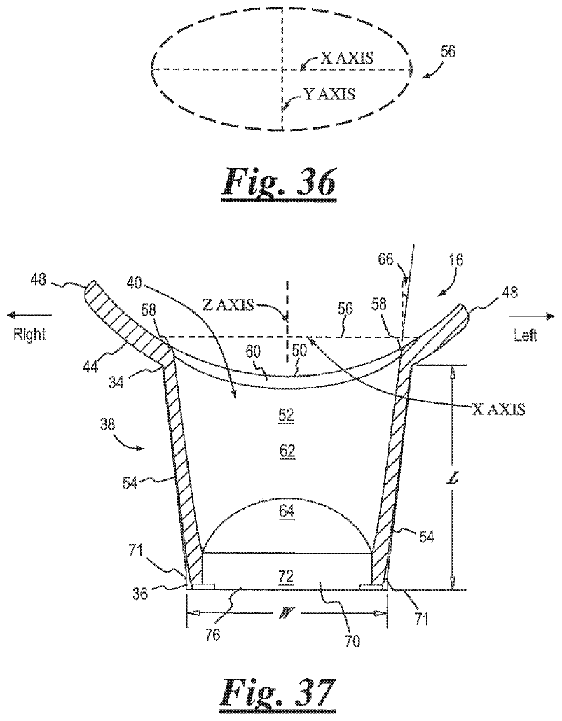

Referring to FIGS. 27-40, mounting flange 44 includes an opening 50 at proximal end 34 of interior passage 40. Opening 50 has an ovoid shape and is configured to receive viscous food paste 22. Interior passage 40 tapers asymmetrically in two dimensions (see FIGS. 30, 33-35) slightly from opening 50 downstream toward distal end 36.

Valve 38 includes a pair of opposing flap walls 52 joined by a pair of opposing side walls 54, the flap walls and side walls together forming continuous interior passage 40. Referring to FIG. 37, valve 38 has a side exterior linear dimension length “L” and a bottom exterior linear dimension width “W”. In one embodiment, “L” and “W” are from about 1.65 inches to about 2.2 inches, and preferably “L” is about 2.0 inches and “W” is about 1.65 inches. Referring to FIG. 38, valve 38 has an exterior linear dimension depth “D” of about 0.75 inches to about 1.25 inches, and exemplarily about 0.85 inches.

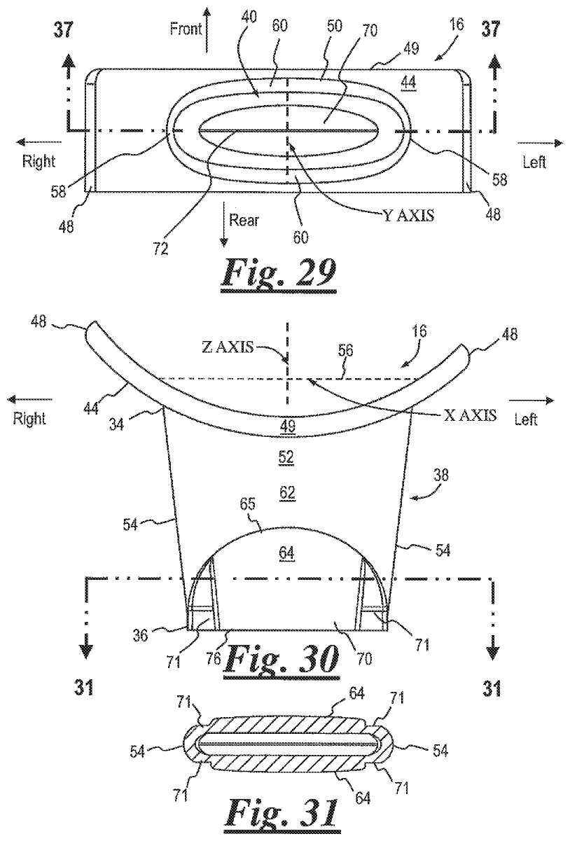

Referring to FIGS. 30, 33 and 36, a reference planar oval 56 is visualized as located above opening 50, in the X-Y plane; the reference planar oval having a central X axis, Y axis and perpendicular Z axis. Opening 50 has a generally concave curvature about the Y axis configured to match the curvature of annular sidewall 415 of discharge cover 414. To reduce pressure drop of the pressurized supply flow of viscous food paste 22 through opening 50, the interior transition from flange 44 to side walls 54 and flap walls 52 is formed in a radius curvature. Referring to FIGS. 29-39, the transition from flange 44 to side walls 54 has a generally convex curvature 58 relative to the Z axis and the transition from the flange to flap walls 52 has a generally convex curvature 60 relative to the Z axis.

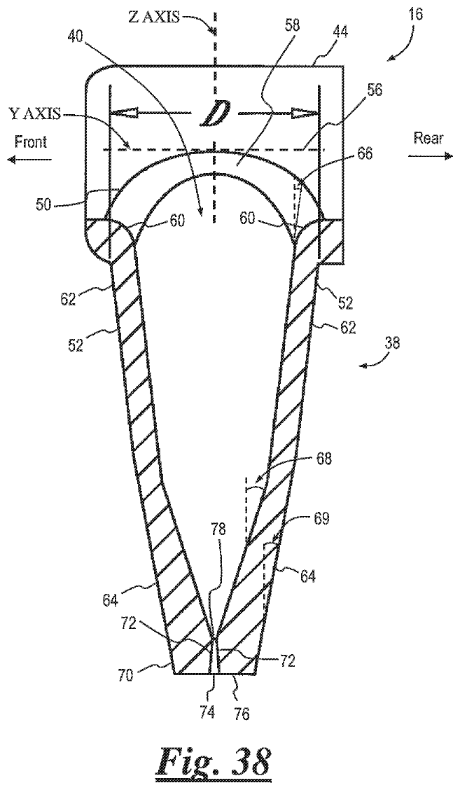

Valve 38 is biased in a normally closed position (see FIG. 38) and flexes to an open position (see FIG. 39) due to a pressure exerted by the discharge of viscous food paste 22. Valve 38 has a generally duckbill shape, and includes a sheath portion 62 and a flexible portion 64. Sheath portion 62 is located on side walls 54 and on the upper portion of flap walls 52. On flap walls 52, flexible portion 64 forms a curved interface 65 with sheath portion 62. Sheath portion 62 is configured with a lesser interior taper angle 66 from about 7 degrees to about 8 degrees relative to the Z axis. Flexible portion 64 is located on flap walls 52 and is configured with a greater interior taper angle 68. In one embodiment, the wall thickness of flexible portion 64 increases as it tapers towards port 70. At the section center cut of FIG. 38, the greater interior taper angle 68 is about 18 degrees and a greater exterior taper angle 69 is from about 11 degrees to about 14 degrees, relative to the Z axis. Flexible portion 64 is configured to be biased in a normally closed position and flexes outward slightly toward the exterior as the pressurized supply flow of viscous food paste 22 is forced downstream through interior passage 40 (see FIG. 39).

Interior passage 40 is defined by opening 50 and the proximal ends 34 of flap walls 52, having a generally ovoid cross-section about the Z axis, that gradually decreases in cross sectional area downwardly (along the Z axis) towards a normally closed port 70 of flexible nozzle 16 at distal end 36. Port 70 is configured for operation from the biased normally closed position to the open position for discharge of viscous food paste 22 in the elongated stream 24. Elongated stream 24 may be captured by the user within a container below port 70 (see FIG. 15).

Port 70 is configured such that the force from the pressurized supply flow of viscous food paste 22 urges the port open and once the supply flow is depressurized and the force ceases, the removal of the force causes the port to return to the normally closed position (FIG. 38). Port 70 will move to the open position when the product processing pressure of the supply flow of viscous food paste 22 reaches a predetermined valve threshold pressure, and will return to the closed position when the product processing pressure falls below the valve threshold pressure.

Each flexible portion 64 includes opposing pairs of tapered stiffening portions 71 adjacent to side walls 54. At each side wall 54 adjacent stiffening portions 71 taken together are configured to be from about two-thirds to about one-half of the width of port 70 at distal end 36, and are configured to assist in biasing the port into the closed position.

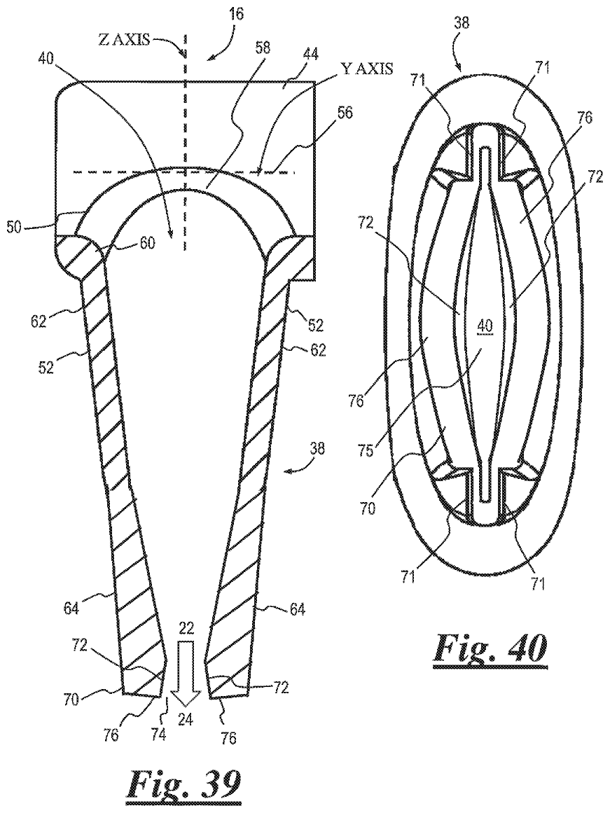

Port 70 includes a pair of opposing gates 72 at the distal end 36 of the interior surfaces of flap walls 52. In the closed position, gates 72 have the appearance of a substantially closed elongated slit. As gates 72 are forced open by the pressurized supply flow of viscous food paste 22 to form an outlet 74. As the slit opens, the middle portion thereof opens relatively more than the end portions to form a bulbous middle portion 75. In other words, gates 72 each deform in a generally bell-like, somewhat concave curvature, to form an ovaloid shaped middle portion 75 of outlet 74 (see FIG. 40).

Valve 38 of nozzle 16 is configured to reduce the amount of paste residue attached to external face 76 by effectively severing the elongated stream 24 without causing excessive pressure drop when the valve is in the open position.

Referring to FIG. 38, gates 72 are configured to be angled slightly relative to each other along the X axis from a pinch point 78 down towards a gap at outlet 74, and thus are biased to abut close together at the pinch point when port 70 is in the normally closed position. As such, gates 72 of port 70 are configured to pinch or chop against elongated stream 24 as the port returns to the closed position, effectively slicing through or breaking apart the elongated stream. The severed elongated stream 24 falls into the user's container below, thereby reducing the amount of residue viscous food paste 22 remaining attached to external face 76 of port 70.

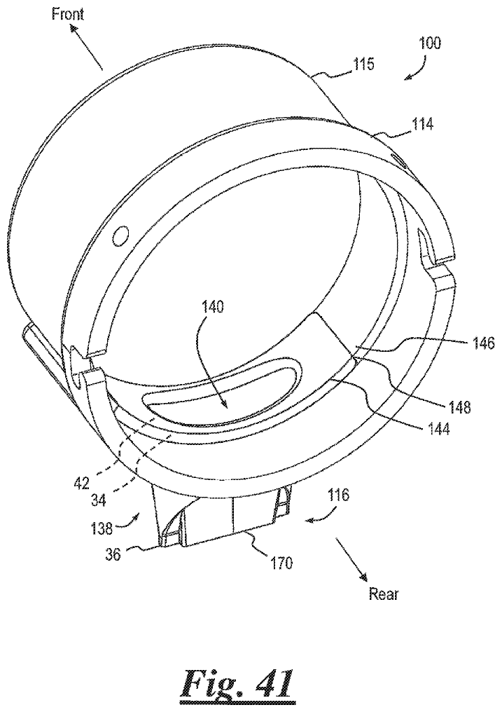

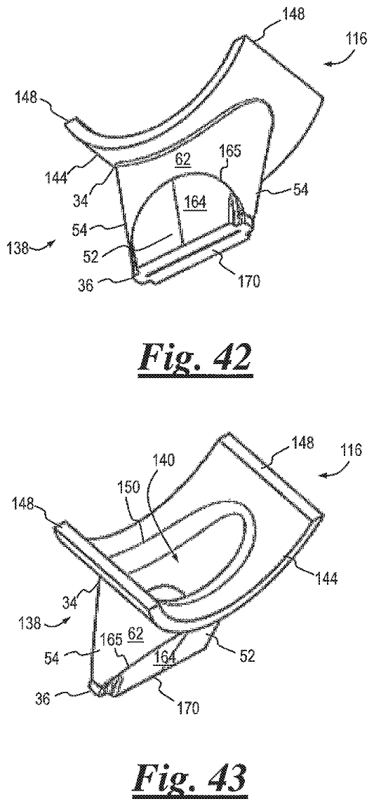

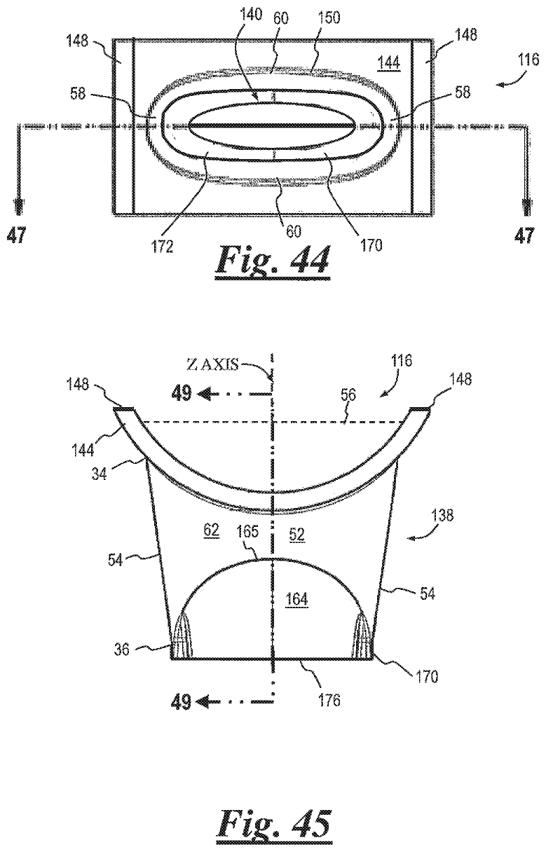

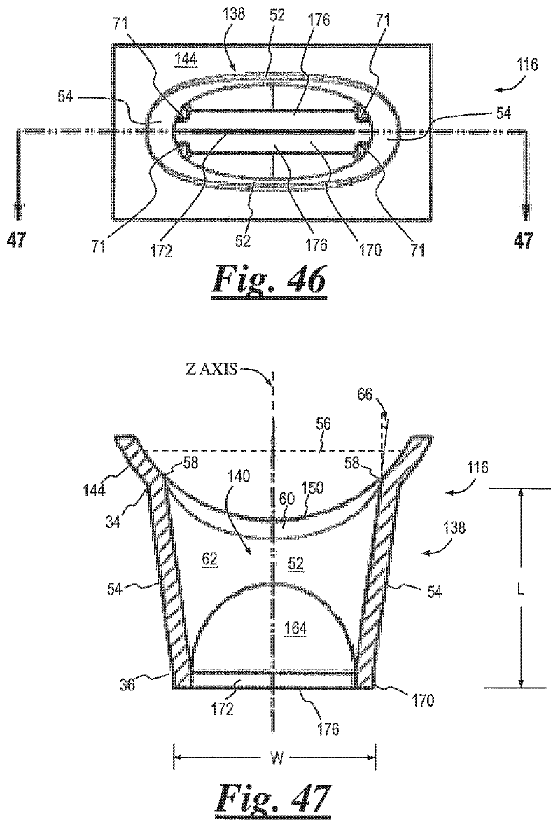

Now referring to FIGS. 41-50, in an alternative embodiment, an outlet adapter 100 includes a discharge cover 114 and a flexible nozzle 116. Nozzle 116 has many similar features to nozzle 16 described above (see FIGS. 27-40). Nozzle 116 is coupled at the proximal end 34 to an aperture 42 in annular sidewall 115 of discharge cover 114. Nozzle 116 includes a valve 138 and a mounting flange 144 at the proximal end 34 configured to fit against the concave curved interior surface of discharge cover 114. Discharge cover 114 may include a shoulder 146 configured to abut the outer edges 148 of mounting flange 144. Referring to FIG. 43, mounting flange 144 includes an opening 150 at proximal end 34 of an interior passage 140 configured to receive viscous food paste 22.

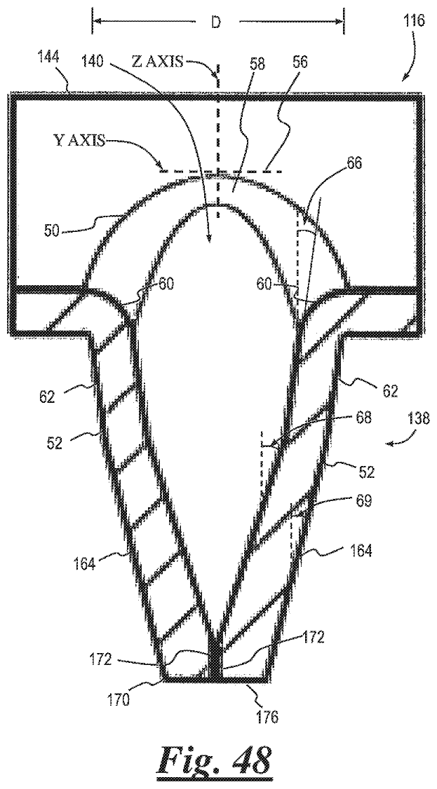

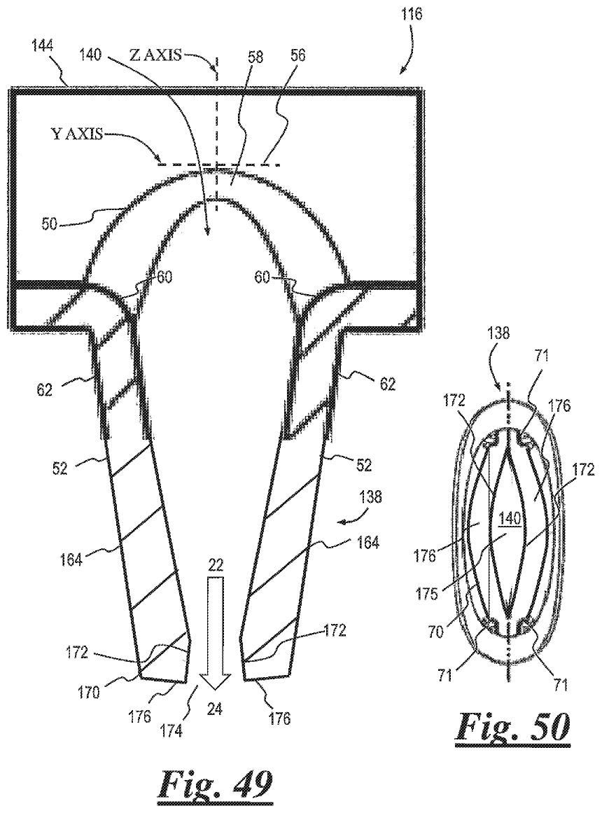

Valve 138 is biased in a normally closed position (see FIG. 48) and flexes to an open position (see FIG. 49) due to a pressure exerted by the discharge of viscous food paste 22. Valve 138 has a generally duckbill shape, and includes sheath portion 62 and a flexible portion 164. On flap walls 52, flexible portion 164 forms a curved interface 165 with sheath portion 62.

Interior passage 140 is defined by opening 150 and the proximal ends 34 of flap walls 52, having a generally ovoid cross-section about the Z axis, that gradually decreases in cross sectional area downwardly (along the Z axis) towards a normally closed port 170 of flexible nozzle 116 at distal end 36. Port 170 is configured for operation from the biased normally closed position to the open position for discharge of viscous food paste 22 in the elongated stream 24.

Port 170 includes a pair of opposing gates 172 at the distal end 36 of the interior surfaces of flap walls 52. In the closed position, gates 172 have the appearance of a closed slit. As gates 172 are forced open by the pressurized supply flow of viscous food paste 22 to form an outlet 174. As the slit opens, the middle portion thereof opens relatively more than the end portions to form a bulbous middle portion 175. In other words, gates 172 each deform in a generally bell-like, somewhat concave curvature, to form an ovoid shaped middle portion 175 of outlet 174 (see FIG. 50).

Gates 172 are configured to be substantially parallel, and are further configured to be biased to abut together when port 170 is in the normally closed position. As such, gates 172 of port 170 are configured to pinch or chop against elongated stream 24 as the port returns to the closed position, effectively slicing through or breaking apart the elongated stream. The severed elongated stream 24 falls into the user's container below, thereby reducing the amount of residue viscous food paste 22 remaining attached to an external face 176 of port 170.

Nozzles 16, 116 are made of a suitable flexible, elastomeric material, such as rubber, for example. Preferably, the rubber is a food grade suitable for use with various particulate food products 20. The nozzle material may be configured of a durometer hardness to match the type of product used for milling, and the type of viscous food paste 22 produced by the viscous food product grinding and dispensing system 12. The durometer hardness utilized is coordinated to allow the valves 38, 138 to deform and open when interior passages 40, 140 are pressurized above a predetermined level and to seal closed causing a reduced residue drip when depressurized. In one example, for use with peanuts to make nut butter, the durometer of the rubber used for the nozzle may be from about Shore 60A to about Shore 90A. The durometer may vary depending on the size of the nuts used, and the texture of nut butter desired (chunky, coarse or smooth). The desired dispense rate of elongated stream 24 is also taken into account with the selection of rubber durometer. In one embodiment, larger sized peanuts produced a rate of about 1.3 lbs/minute to about 1.4 lbs/minute. In another embodiment, smaller sized peanuts produced a rate of about 3.1 lbs/minute to about 3.6 lbs/minute. In one embodiment, flexible nozzle 116 is preferably made from Shore 80A rubber for use in peanut butter applications to produce a flow rate of about 1.5 to about 3.4 lbs/minute of peanut food paste. The Shore 80A flexible nozzle 116 produces a dispense rate from about 3.2 to 3.4 lbs/minute with smaller sized peanuts and from about 1.5 to 1.7 lbs/minute with larger sized peanuts.

Discharge covers 114, 414, 614 may be made from a suitable food grade metal, such as stainless steel for example. Flexible nozzles 16, 116 are easily inserted and removed for cleaning from aperture 42 in discharge covers 114, 414, 614. Various parts shown are interchangeable in different system embodiments. For example, transport device 432 may be used within front housing 628. Although shown coupling with the annular sidewall 115, 415 of cylindrical discharge covers 114, 414, and having a generally U-shaped flanges 44, 144, valves 38, 138 may be used in other applications, such as inline in industrial food processing. Valves 38, 138 may be mounted inline in a square, cylindrical or rounded conduit, where the corresponding flange perimeter is square, circular, or rounded and configured to mate with the adjacent conduit structure. The viscous food product dispensed by valves 38, 138 may be any suitable food product, such as dough, jam or mayonnaise. The valves may also be utilized with other suitable viscous products such as caulk, adhesives or petroleum jelly.

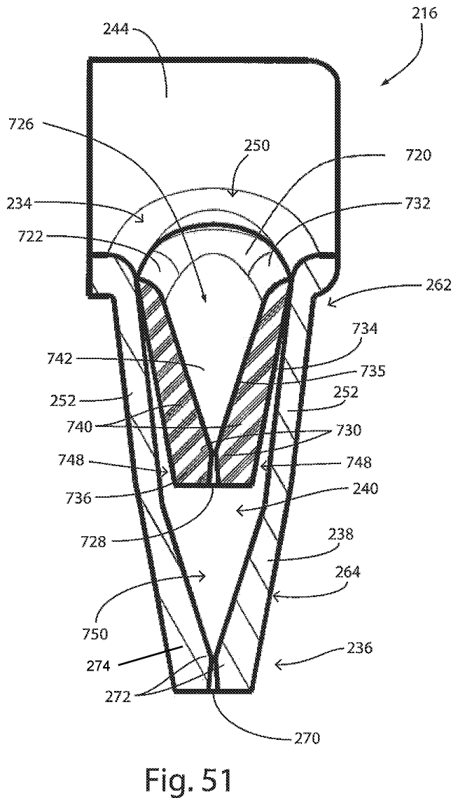

FIGS. 51-56 provide an example of a nozzle 216 configured for use with a viscous food product grinding and dispensing system 412 as schematically shown and described with respect to FIGS. 15 and 16. As will be described herein, the inventors have recognized that the nozzles 16, 116 described above may have susceptibility to leaking when used to dispense food paste with a low viscosity, or a low viscosity component. The improvements disclosed herein provide viscous food product grinding and dispensing system with a nozzle 216 with improved performance in adequately dispensing low viscosity food pastes, thus providing a dispensing system that provides improved dispense of food pastes across a wider range of food paste viscosities.

Examples of food product grinding and dispensing systems described above provide systems capable of grinding food pastes from nuts in a manner that is adjustable to accommodate a wide variety of nut conditions (e.g. whole or pre-broken) and output a wide range of food paste consistencies (e.g. “chunky” or “smooth/creamy”). However, with this adjustability and wide range of food paste outputs, it has been discovered that finely ground textured (e.g. “smooth” or “creamy”) food pastes in general have a lower viscosity and are susceptible to leakage after the dispense of the food paste. Food paste leakage is an undesirable result from food paste grinding and dispensing system operation. Therefore, the nozzle 216 provided herein enables these food grinding and dispensing systems to operate in a desirable manner across their operational ranges.

Furthermore, nuts are a natural product and naturally vary in certain product qualities between delivery batches. Using the example of almond nuts, almonds vary in moisture content dependent upon the region in which they are grown and the time in the harvest season (early harvest vs. late harvest) in which the almonds are harvested. These nuts may also exhibit variation in oil content as well. Furthermore, the conditions in which the almonds are stored or processed (e.g. roasted, active drying, oil treatment) before sale affect the moisture content. This natural and handling variation in the almonds themselves manifests itself in variation in the moisture content of almonds received by retailers for point-of-sale grinding of almond paste for consumers. This is similar for other nuts as well. High moisture content of the input bulk nuts results in a less viscus food paste, even when the grinding texture is held constant. In previous use, when the nut moisture content was high, consumers may be directed to use a coarser grind to produce a more viscous paste counteracting the naturally less viscous output. The nozzle 216 as provided herein enables the continued use of food product grinding and dispensing systems across a wide variety of nut moisture contents to produce a wide variety of available food paste grinds.

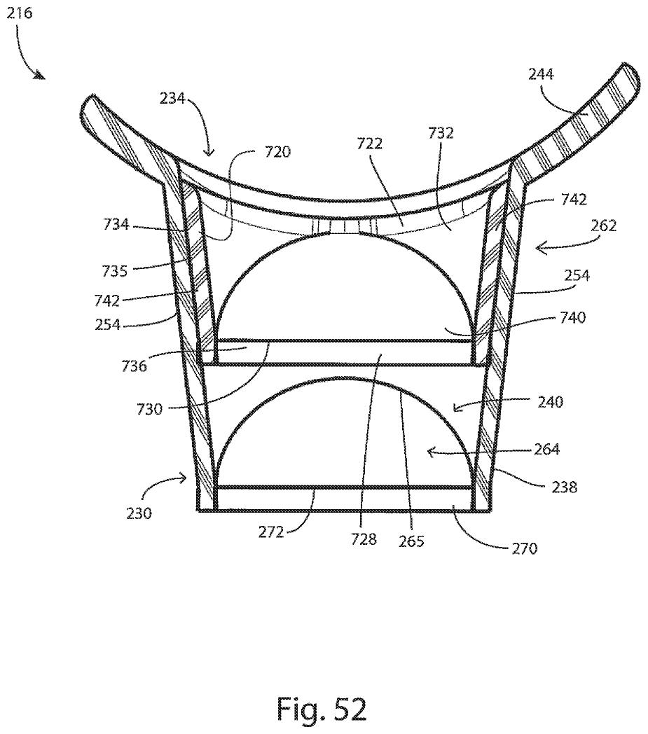

FIG. 51 is a sectional view of the nozzle 216 taken along the Y-Z plane. FIG. 52 is a sectional view of the nozzle taken along the X-Z plane. The nozzle 216 includes a mounting flange 244 and a valve 238. The nozzle 216 has an ovoid opening 250 formed at the proximal end 234 of an interior passage 240 defined by the valve 238. The opening 250 also has a generally concave curvature. The interior passage 240 tapers asymmetrically in two dimensions from the opening 50 downstream toward an outlet 270 at a distal end 236 of the valve 238.

The valve 238 is biased to hold the outlet 270 in a normally closed position and flexes to an open position due to a pressure exerted by the discharge of viscous food paste. Valve 238 may include a generally duckbill shape, and includes a sheath portion 262 and a flexible portion 264. Sheath portion 262 is located on side walls 254 and on the upper portion of flap walls 252. On flap walls 252, flexible portion 264 forms a curved interface 265 with sheath portion 262. Sheath portion 262 is configured with a lesser interior taper angle than a taper angle of the flexible portion 264 of the flap walls 252.

The nozzle 216 further includes a valve insert 720 positioned within the interior passage 240 of the valve 238. The valve insert 720 may exemplarily be a separately constructed component from the valve 238 or may be a unitary construction with the valve 238. The valve insert 720 provides a second barrier against unwanted dispense of food paste, which may be particularly useful to reduce leakage or dripping of low viscosity food paste from the outlet 270 of nozzle 216.

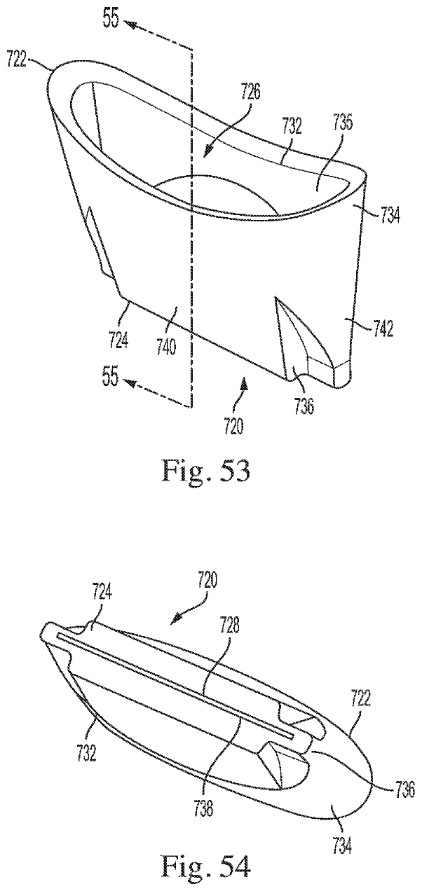

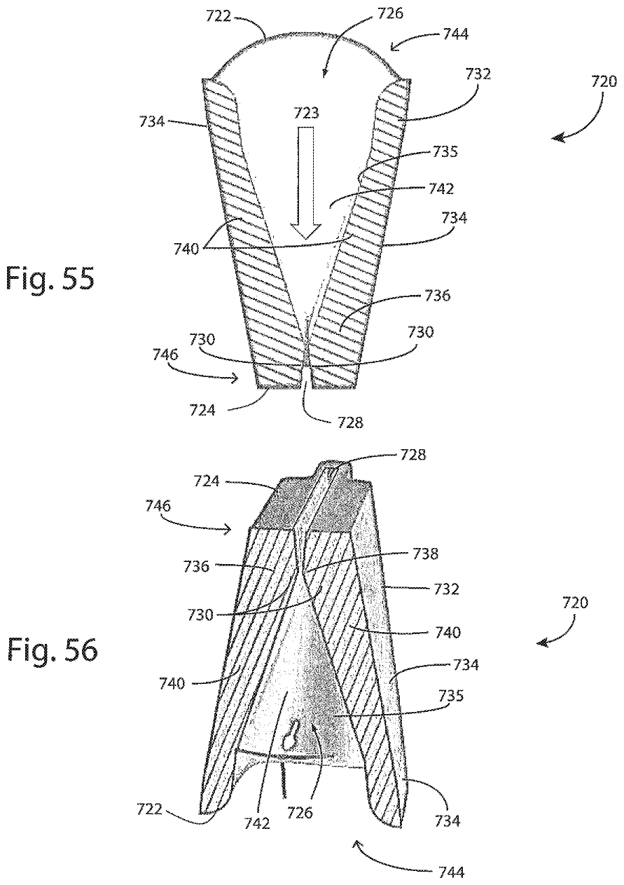

FIGS. 53-56 depict an example of the valve insert 720 in isolation to better illustrate features thereof. FIGS. 55 and 56 provide sectional views of an example of the valve insert 720, exemplarily taken along line 55-55 in FIG. 53. The valve insert 720 includes a body 732 defined by flap walls 740 and lateral walls 742. The valve insert 720 defines an interior passage 726 from an inlet 722 at the proximal end 744 of the valve insert 720 to an outlet 728 at the distal end 746 of the valve insert 720. The flap walls 740 and the lateral walls 742 can define an outer surface 734 that tapers inward asymmetrically in two dimensions between the inlet 722 and the outlet 728 so that the cross-sectional area of the body 732 is larger at the inlet 722 than at the outlet 728. The outer surface 734 at the proximal end 744 further is ovoid in shape, and as described in further detail herein, is similar in shape to the opening 250 of the valve 238. The outer surface 734 of the flap walls 740 tapers inwardly at a greater angle than the outer surface 734 of the lateral walls 742. An inner surface 735 of the passageway 726 may taper inward so that the passage narrows along the flow path from the inlet 722 and the outlet 728. As depicted, the inner surface 735 of the lateral walls 742 taper at an angle similar to that of the outer surface 724 of the lateral walls 742, while the inner surface 735 of the flap walls 740 tapers at a greater angle than the outer surface 724 of the flap walls 740.

A port 736 is positioned in the passageway 726 between the inlet 722 and the outlet 728, and defined by a pair of opposed a gates 730 configured to create a chokepoint in the flow path through the passageway 726. The gates 730 may be formed as ridges on the inner surface 735 of the flap walls 740 in the vicinity of the outlet 728. At least a portion of the body 732 may be formed from a flexible material configured to allow the port 736 to move between an open position in which viscous food product may flow along the flow path through the passageway 726, and a closed position in which the flow of viscous food product is restricted. For example, flap walls 740 and the lateral walls 742 may be sufficiently flexible to allow the gates 730 to move away from each other as the port 736 moves from the closed position to the open position. When the port 736 is in the closed position, the gates 730 form a narrow slot having the minimum cross-sectional area of the passageway 726. The outlet 728 may mirror the cross-sectional shape of the passageway 726 at the gates 730 and have a narrow slot shaped aperture 738 at the exterior face 724. However, other examples may include a port 736 configured so that the gates 730 make contact with each other to completely seal the passage. Under the force of a flow of food paste, the port 736 moves to the open position, with the flap walls 740 flex outward to move the gates 730 away from each other, thereby enlarging the cross-sectional area of the aperture 738 at the chokepoint between the gates 730, as well as enlarging the cross-sectional area of the outlet 728. Further, the side walls 740, 742 may be configured to elastically return to their resting shapes without any permanent deformation, biasing the port 736 into the closed position from the open position. In some embodiments, the port 736 and the outlet may have a generally ovoid shape when in the open position. In other embodiments may be configured to form a different shape when the port 736 is in the open position.

The nozzle 216 thus provides a double valve design in which a valve insert 720 is shown cooperatively fitted within the interior passage 240 of the valve 238. The valve insert 720, if not already a unitary construction with the valve 238, is positioned in engagement between at least portions of the outer surface 734 of the valve insert 720 and portions of the surface of the interior passage 240. When the valve insert 720 is thus seated within the interior passage 240, the valve insert 720 forms a seal with the walls of the nozzle 216. The seal between the valve insert 720 and the nozzle 216 may be sufficiently tight to prevent food product flowing through the interior passage 240 from leaking around the valve insert 720, thereby directing the flow of food paste through the insert passageway 726. Furthermore, as depicted in FIGS. 51 and 52, the valve insert 720 is configured to sit distal the curvature 260 of the opening 250, including a convex shape. Thus the opening inlet 722 of the valve insert 720 does not create an obstruction to the flow of the food paste, but rather continues the reduction in the flow path started by the opening 250.

Looking now to FIGS. 51 and 52, the outer surface 734 of the lateral walls 742 follows in engagement with the surface of the interior passage 240 along the side walls 254. This, for example, promotes the interference fit and liquid-tight securement between the valve insert 720 and the valve 238. However, while the outer surface 734 of the flap walls 740 engage the surface of the interior passage 240 along the flap walls 252 at a region about the proximal end 234 of the interior passage 240, the exterior surface 734 of the flap walls 740 taper inwards at a greater angle than the interior surface 240 of the adjacent flap walls 252 of the valve 238. This creates a gap 748 between the flap walls 740 of the valve insert 720 and the flap walls 252 of the valve 238 that increases distally thorough the interior passage 240 towards the outlet 270. This gap 748 provides the flap walls 740 with a space to expand outwardly in to in order for the port 736 to move to the open position under the force of dispensed food paste.

As previously noted, the nozzle 216 is particularly adapted to dispense food paste, and more specifically, a wide range of viscosities of food paste, including low viscosity food paste. The gates 730 and gates 272 are configured to pinch a stream of food paste as the ports 728, 274 return to the closed positions upon cessation of the food paste flow, thus effectively providing a double chambering or capturing the undispensed food paste. The outlet 728 retains the bulk of the volume of the food paste upstream of the nozzle 216, for example in the milling device and the discharge cover towards the grinder. Such an arrangement may be useful, for example, to prevent low viscosity food product from syphoning from the grinder, and keeping product from accidentally dripping ultimately through the outlet 270.

When used with a viscous food dispensing system that provides pressurized flow of food product to the nozzle 216, the food product retained behind the port 736 may exert a pressure on the tapered interior surface 735. As the paste dispense is initiated, pressure exerted on the flap walls 740 may increase until a threshold is exceeded, at which point the viscous food product will force the flap walls 740 to expand outward into the gap 748, thereby moving the port 736 into the open position and allowing the food paste to flow through the valve insert 720 and out of the outlet 728. The food paste out of the outlet 728 flows into a chamber 750 defined between the outside of the valve insert 720 and the interior surface of the valve 238. The food paste built up within the chamber 750 exerts force against the flexible portions 264 of the flap walls 254, until a threshold is exceeded and the flap walls 254 expand to separate the gates 272 and open the port 274 to open nozzle 216 to a flow of the food paste through the nozzle 216 and out of outlet 270.

Once the pressure exerted on the flap walls 740 by the viscous food product decreases below the biased threshold of the flap, the flap walls 740 may move back inward, moving the gates 730 towards each other and returning the port 736 to the closed position. As the port 736 closes, the gates 730 cut off the stream of viscous food paste to restrict flow through the passageway 726. With the flow of food paste from the outlet 728 restricted or stopped, the valve 238 of the nozzle 216 similarly returns from the open position to the closed position.

The port 736 of the valve insert 720 can be configured so that, while it is in the closed position, flow of the viscous food product through the nozzle 216 is restricted by the gates 730. Even if, in the closed position, the port 736 leaves a narrow opening through the passageway 726, the size of the aperture 738 between the gates 730 can be dimensioned to prevent or limit the flow food paste out of the port 736. The dimensions of the aperture 738 may be selected based on at least one of an expected viscosity or viscosity range of the flowing food paste, a flow rate or flow rate range of the food paste into the nozzle 216, a flow pressure or pressure range of the food paste, and any other characteristic of the food product of the dispensing system.

The nozzle 216 prevents leakage of low viscosity food paste when the nozzle is in the closed position. The valve insert 720, when in the closed position, limits the pressure of food paste remaining in the chamber 750 within the nozzle 216 against the gates the port 274. In this manner, only the food paste that does make it through port 736 ends up in the chamber. Until the chamber 750 is full, the food paste in the chamber 750 is separated from the food paste in the rest of the system and the hydraulic force on the port 274 is limited. The port 736 bears the pressure of the food paste held within the system. Additionally, as food paste is collected in the chamber 750, this food paste may accumulate in the gaps 748. The food paste accumulated in the gaps 748 further provide resistance against the flap walls 740, increasing the resistance of the port 736 to further leakage.

While this invention has been shown and described with respect to detailed embodiments thereof, it will be understood by those skilled in the art that changes in form and detail thereof may be made without departing from the scope of the claims of the invention.

what is claimed is:

1. A nozzle for a viscous food dispensing system configured to dispense a viscous food product, the nozzle comprising:
a nozzle passage defined by opposed side walls and opposed flap walls, the nozzle passage extending from a nozzle inlet to a nozzle outlet;
a first port positioned proximate the nozzle outlet;
a valve insert positioned within the nozzle passage between the nozzle inlet and the first port, the valve insert comprising a second port; and
wherein the first port and the second port are configured to move between an open position and a closed position in which flow from the nozzle inlet to the nozzle outlet is first restricted within the valve insert by the second port then restricted from the nozzle outlet by the first port.

2. The nozzle of claim 1, wherein the valve insert includes a body configured to be received in the nozzle passage, the body including an insert passageway extending from an insert inlet to an insert outlet, and an outer surface configured to form a seal with an interior surface of the nozzle passage thereby directing flow of viscous food product through the insert passageway.

3. The nozzle of claim 2, wherein the outer surface of the valve insert proximate the insert inlet is contoured to match interior surface of the nozzle passage proximate the nozzle inlet.

4. The nozzle of claim 3, wherein the body of the valve insert comprises opposed flap walls and opposed lateral walls and the opposed lateral walls of the body of the valve insert engage the interior surface of the nozzle passage at the side walls along a length of the opposed lateral walls.

5. The nozzle of claim 4, wherein the opposed flap walls of the body of the valve insert angle interiorly away from the interior surface of the nozzle passage at the flap walls defining the nozzle passage to form a gap therebetween.

6. The nozzle of claim 2, wherein the second port includes opposing gates positioned on insert flap walls that extend towards each other from opposite sides of the nozzle passage; and
wherein the insert flap walls are configured to flex outward to move the opposing gates away from each other thereby moving second port into the open position from the closed position, and to flex inward to move the opposing gates towards each other thereby moving the second port into the closed position from the open position.

7. The nozzle of claim 6, wherein the opposing gates converge on a narrow aperture between the opposing gates when the second port is in the closed position; and
wherein the opposing gates are configured to move away from each other to expand the aperture when the second port moves from the closed position to the open position.

8. The nozzle of claim 6, wherein the opposing gates are configured to engage when the second port is in the closed position; and
wherein opposing gates are configured to move away from each other out of engagement to form an aperture when the second port moves from the closed position to the open position.

9. The nozzle of claim 6, wherein a gap is formed between an outer surface of the insert flap walls and an interior surface defining the nozzle passage.

10. The nozzle of claim 6, wherein the first port includes nozzle flap walls that are tapered inward towards each other from opposite sides of the nozzle passage; and
wherein an outer surface of the insert flap walls is tapered inward at a greater angle than an interior surface of the adjacent nozzle flap walls to form gap therebetween.

11. The nozzle of claim 2, wherein the first port is spaced apart from the second port and the second port provides a seal against the flow of food product into a space formed between the valve insert and the first port in the nozzle passage.

12. The nozzle of claim 2, wherein the first port and the second port are integrally formed with a body of the nozzle.

13. The nozzle of claim 1, wherein the valve insert configured to be removably received in the nozzle passage.

14. A system for grinding nuts into a food paste and dispensing the paste therefrom comprising:
an auger for preprocessing nuts into nut particulates;
a milling device that receives nut particulates and grinds the nut particulates into a pressurized flow of viscous food paste;
a discharge cover surrounding at least a portion of the milling device, the discharge cover directs the viscous food paste away from the milling device;
a nozzle fluidly connected to the discharge cover, the nozzle comprising:
a nozzle passage defined by opposed side walls and opposed flap walls, the nozzle passage extending from a nozzle inlet to a nozzle outlet;
a first port positioned proximate the nozzle outlet;
a valve insert positioned within the nozzle passage between the nozzle inlet and the first port, the valve insert comprising a second port; and
wherein the first port and the second port are each configured to move between an open position and a closed position in which flow from the nozzle inlet to the nozzle outlet is first restricted within the valve insert by the second port then restricted from the nozzle outlet by the first port.

15. The system of claim 14, wherein the milling device comprises texture adjustment to provide food pastes with a variety of viscosities.

16. The system of claim 14, wherein the valve insert includes a body configured to be received in the nozzle passage, the body including an insert passageway extending from an insert inlet to an insert outlet, and an outer surface configured to form a seal with an interior surface of the nozzle passage thereby directing flow of viscous food product through the insert passageway.

17. The system of claim 16, wherein the outer surface of the valve insert proximate the insert inlet is contoured to match interior surface of the nozzle passage proximate the nozzle inlet, the body of the valve insert comprises opposed lateral walls that engage the interior surface of the nozzle passage at the side walls along a length of the opposed lateral walls, and the body of the valve insert comprises opposed flap walls that angle interiorly away from the interior surface of the nozzle passage at the flap walls defining the nozzle passage to form a gap therebetween.

18. The nozzle of claim 16, wherein the second port includes opposing gates positioned on insert flap walls that extend towards each other from opposite sides of the nozzle passage; and
wherein the insert flap walls are configured to flex outward to move the opposing gates away from each other thereby moving second port into the open position from the closed position, and to flex inward to move the opposing gates towards each other thereby moving the second port into the closed position from the open position.

19. The nozzle of claim 18, wherein a gap is formed between an outer surface of the insert flap walls and an interior surface defining the nozzle passage.

20. The nozzle of claim 18, wherein the first port includes nozzle flap walls that are tapered inward towards each other from opposite sides of the nozzle passage; and
wherein an outer surface of the insert flap walls is tapered inward at a greater angle than an interior surface of the adjacent nozzle flap walls to form gap therebetween.
